(19) United States
(12) Patent Application Publication
(10) Pub. No.: US 2022/0390406 A1
(43) Pub. Date: Dec. 8, 2022

(54) HUMIDITY SENSOR DIAGNOSIS DEVICE

(71) Applicant: HITACHI ASTEMO, LTD., Hitachinaka-shi, Ibaraki (JP)

(72) Inventors: Eisaku FUKUCHI, Hitachinaka-shi (JP); Takahiro MIKI, Hitachinaka-shi (JP); Hiroaki HOSHIKA, Hitachinaka-shi (JP)

(73) Assignee: HITACHI ASTEMO, LTD., Hitachinaka-shi, Ibaraki (JP)

(21) Appl. No.: 17/775,166

(22) PCT Filed: Oct. 20, 2020
(86) PCT No.: PCT/JP2020/039325

§ 371 Date: May 6, 2022

(30) Foreign Application Priority Data
Nov. 8, 2019 (JP) 2019-203278

(51) Int. Cl. G01N 27/22

(52) U.S. Cl. CPC G01N 27/223

(57) ABSTRACT

A diagnostic function of a humidity sensor is exposed to the outside and the humidity sensor is likely to deteriorate.

An aspect of the present invention includes: a capacitance-voltage conversion circuit which includes a plurality of reference capacitors having different pieces of capacitance and a switch which switches the reference capacitors and outputs a voltage according to the capacitance of a humidity sensor; and a diagnosis unit which compares an output voltage of the capacitance-voltage conversion circuit with a reference voltage obtained from a reference characteristic of the humidity sensor and diagnoses the humidity sensor based on a comparison result. Also, the diagnosis unit changes the output voltage by changing the capacitance of the capacitance-voltage conversion circuit using the switch in a state in which the output voltage of the capacitance-voltage conversion circuit is within a certain range and compares the changed output voltage with the reference voltage.

### TECHNICAL FIELD

The present invention relates to a humidity sensor diagnosis device which performs diagnosis with respect to a humidity sensor.

### BACKGROUND ART

As a means for reducing the amount of harmful exhaust gases from an automobile and improving fuel efficiency and drivability, a feedback type air-fuel ratio control device which controls an air-fuel ratio using information about the exhaust gas components from engines such as an internal combustion engine has been put into practical use.

In an air-fuel ratio control device, an abnormality in the exhaust gas components or an abnormality in a control system may not be suitably controlled due to a failure or deterioration of an air flow sensor which is used (air amount measurement) in some cases. In recent years, multifunctional sensors have been adopted to improve the accuracy of air flow sensors and examples of such sensors include air flow sensors, intake air temperature sensors, and humidity sensors. Particularly, in the case in which an intake air amount is measured by an air flow sensor, the intake air amount is exposed through explosion, contaminants flow into a humidity sensor element (polymer sensitive film), and detection accuracy degrades or deteriorates. Note that, the humidity detected from the humidity sensor is used for correction of the intake air amount, correction of other control, and the like.

Vehicles destined for North America need to comply with the OBD2 regulations (laws requiring the installation of an in-vehicle self-diagnosis device). In the case in which a failure which exceeds 1.5 times an exhaust limit value occurs due to deterioration of the humidity sensor, it is necessary to promptly warn the driver of the abnormality and encourage a driver to repair a vehicle. Therefore, when the detection accuracy of the humidity sensor decreases for some reason, it is necessary to perform an appropriate treatment such as replacement of the humidity sensor (in the case of multifunctional sensors, each multifunctional sensor needing to be replaced).

Therefore, in the present invention, a technique for accurately diagnosing a humidity sensor is required and a detection method thereof is provided.

PTL 1 discloses an invention relating to diagnosis of a humidity sensor. In the technique disclosed in PTL 1, first capacitance Ct1 and second capacitance Ct2 (dielectric films) for diagnosis are provided in an abnormality detection element (humidity sensor itself) and deterioration in characteristics of first variable capacitance C1 and second variable capacitance C2 which is used for capturing a change in humidity is determined.

### CITATION LIST

### Patent Literature

PTL 1: JP 2014-10011 A

### SUMMARY OF INVENTION

### Technical Problem

However, in the technique described in PTL 1, since an abnormality detection element, that is, a humidity sensor itself includes the first capacitance Ct1 and the second capacitance Ct2 which are a part of a diagnostic functional part, the diagnostic function is exposed to the outside world and there is an aspect in which the diagnostic function easily deteriorates.

From the above situation, a humidity sensor diagnosis device in which the detection accuracy of the diagnostic function is less likely to deteriorate is desired.

### Solution to Problem

In order to solve the above problems, a humidity sensor diagnosis device according to an aspect of the present invention is a humidity sensor diagnosis device which performs diagnosis with respect to a humidity sensor configured to detect a humidity of intake air via change in capacitance present in an intake air system of an internal combustion engine, the humidity sensor diagnosis device including: a capacitance-voltage conversion circuit which includes a plurality of reference capacitors having different capacitances and a switch configured to switch between the reference capacitors, and outputs a voltage in accordance with the capacitance of the humidity sensor; and a diagnosis unit which compares an output voltage of the capacitance-voltage conversion circuit with a reference voltage obtained from reference characteristics of the humidity sensor and diagnoses the humidity sensor based on a comparison result. Also, the diagnosis unit changes the output voltage by changing the capacitance of the capacitance-voltage conversion circuit using the switch in a state in which the output voltage of the capacitance-voltage conversion circuit is within a certain range and compares the changed output voltage with the reference voltage.

### Advantageous Effects of Invention

According to at least one aspect of the present invention, by adopting a configuration in which a plurality of reference capacitors having different pieces of capacitance are provided in a capacitance-voltage conversion circuit and diagnosis is performed by switching the reference capacitors, the plurality of reference capacitors are not exposed to an inflow gas so that detection accuracy of a diagnosis function is less likely to deteriorate.

Problems, configurations, and effects other than those described above will be clarified by the following description of embodiments.

### BRIEF DESCRIPTION OF DRAWINGS

FIG. 1 is a block diagram illustrating a configuration example of a humidity sensor diagnosis device according to a first embodiment of the present invention.

FIG. 2 is a diagram illustrating an example of an internal combustion engine system in which the humidity sensor diagnosis device according to the first embodiment of the present invention is used.

FIG. 3 is a block diagram illustrating a configuration example of a multifunction sensor including a general humidity sensor (relative humidity sensor).

FIG. 4 is a diagram illustrating an exemplary structure of a humidity sensor.

FIG. 5 is a diagram for explaining the principle of a humidity sensor.

FIG. 6 is a graph for describing an example of a relationship between relative humidity RH and capacitance of a humidity sensor.

FIG. 7 is a C-V conversion circuit that outputs a voltage corresponding to the capacitance of a humidity sensor in the related art.

FIG. 8 is a diagram for examining causes of deterioration (manner of deterioration) of a humidity sensor.

FIG. 9 is a graph for describing gain deterioration, drift (offset) deterioration, and response deterioration.

FIG. 10 is a diagram illustrating an example of a CV conversion circuit provided in the humidity sensor diagnosis device according to the first embodiment of the present invention.

FIG. 11 is a diagram illustrating an example of a diagnosis sequence using the C-V conversion circuit according to the first embodiment of the present invention.

FIG. 12 is a graph for describing a method of detecting gain deterioration using the humidity sensor diagnosis device according to the first embodiment of the present invention.

FIG. 13 is a graph for describing a method of detecting drift (offset) deterioration using the humidity sensor diagnosis device according to the first embodiment of the present invention.

FIG. 14 is a timing chart for describing an example of a response deterioration behavior of the humidity sensor when a heater is turned on.

FIG. 15 is a diagram illustrating a method of detecting response deterioration of the humidity sensor when the heater is turned on using the humidity sensor diagnosis device according to the first embodiment of the present invention.

FIG. 16 is a diagram illustrating an example of a detection result of response deterioration of the humidity sensor when the heater is turned on using the humidity sensor diagnosis device according to the first embodiment of the present invention.

FIG. 17 is a diagram illustrating a method of detecting response deterioration of the humidity sensor when the heater is turned off using the humidity sensor diagnosis device according to the first embodiment of the present invention.

FIG. 18 is a flowchart for describing a procedure example of gain/drift diagnosis region determination processing using a gain/drift diagnosis region determination unit according to the first embodiment of the present invention.

FIG. 19 is a flowchart illustrating an output processing example of a C-V conversion circuit of the humidity sensor diagnosis device according to the first embodiment of the present invention.

FIG. 20 is a flowchart for describing a procedure example of the gain/drift deterioration detection processing using the humidity sensor diagnosis device according to the first embodiment of the present invention.

FIG. 21 is a flowchart for describing a procedure example of response deterioration diagnosis region determination processing when the heater is turned on using the humidity sensor diagnosis device according to the first embodiment of the present invention.

FIG. 22 is a flowchart for describing a procedure example of falling response deterioration detection processing when the heater is turned on using the humidity sensor diagnosis device according to the first embodiment of the present invention.

FIG. 23 is a flowchart for describing a procedure example of rising response deterioration detection processing when the heater is turned on using the humidity sensor diagnosis device according to the first embodiment of the present invention.

FIG. 24 is a flowchart for describing a procedure example of response deterioration diagnosis region determination processing when the heater is turned off using the humidity sensor diagnosis device according to the first embodiment of the present invention.

FIG. 25 is a flowchart for describing a procedure example of a falling response deterioration detection processing when the heater is turned off using the humidity sensor diagnosis device according to the first embodiment of the present invention.

FIG. 26 is a diagram illustrating an example of a CV conversion circuit provided in a humidity sensor diagnosis device according to a second embodiment of the present invention.

### DESCRIPTION OF EMBODIMENTS

Examples of modes for carrying out the present invention will be described below with reference to the accompanying drawings. In the present specification and the accompanying drawings, constituent elements having substantially the same function or configuration are denoted by the same reference numerals and redundant description is omitted.

### 1. First Embodiment

First, a humidity sensor diagnosis device according to a first embodiment of the present invention and a diagnostic method using the humidity sensor diagnosis device will be described in detail. In the embodiment, an example of diagnosing a humidity sensor provided in an intake air system of an internal combustion engine in an automobile will be described.

[Configuration of Humidity Sensor Diagnosis Device]

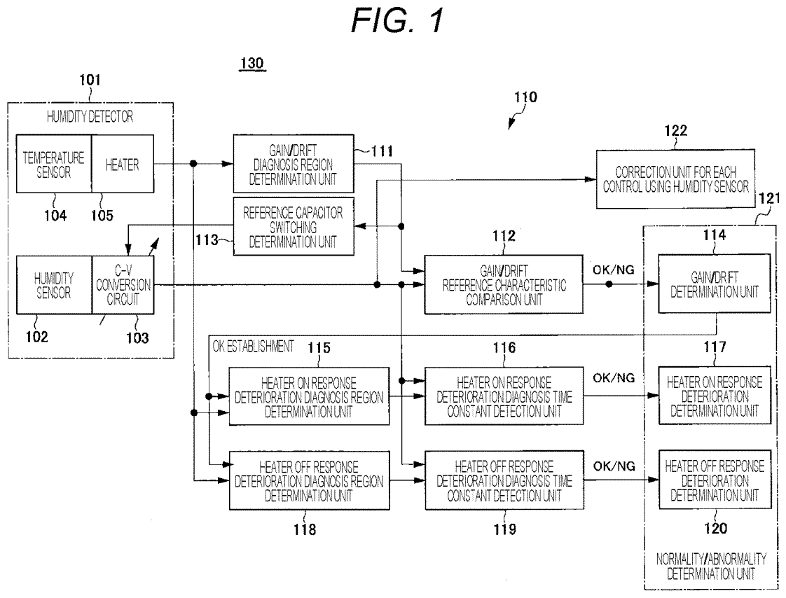

FIG. 1 is a block diagram illustrating a configuration example of the humidity sensor diagnosis device according to the first embodiment.

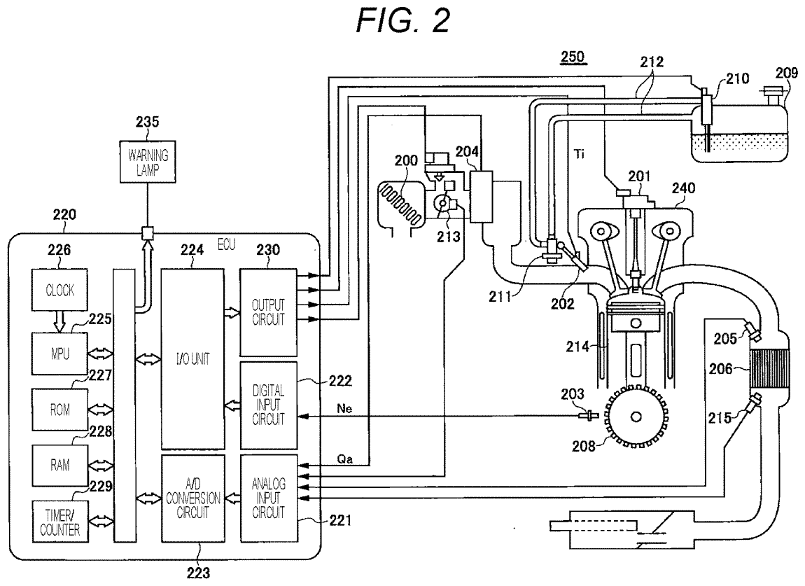

A humidity detector 101 includes a humidity sensor 102, a capacitance-voltage conversion circuit 103, a temperature sensor 104 (humidity temperature sensor), and a heater 105 which heats the humidity sensor 102. The humidity sensor 102 is provided in an intake air system of an internal combustion engine 240 (refer to FIG. 2) which will be described later.

A humidity sensor diagnosis device 130 illustrated in FIG. 1 includes a capacitance-voltage conversion circuit 103 and a diagnosis unit 110. Hereinafter, the capacitance-voltage conversion circuit is referred to as a “C-V conversion circuit.”

The humidity detector 101 including the humidity sensor 102 with the heater 105 converts humidity into a voltage and detects the voltage. Here, the humidity sensor 102 detects humidity using the fact that the capacitance changes in accordance with the humidity. The humidity sensor 102 is controlled to a constant temperature using the temperature sensor 104 and the heater 105. The C-V conversion circuit 103 is a circuit which outputs a voltage in accordance with to the capacitance of the humidity sensor 102, that is, converts the capacitance into a voltage.

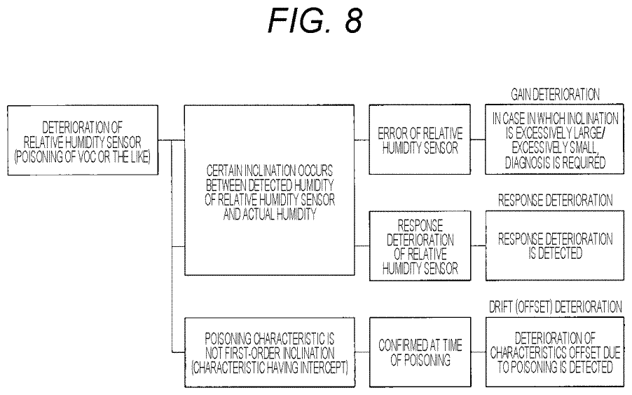

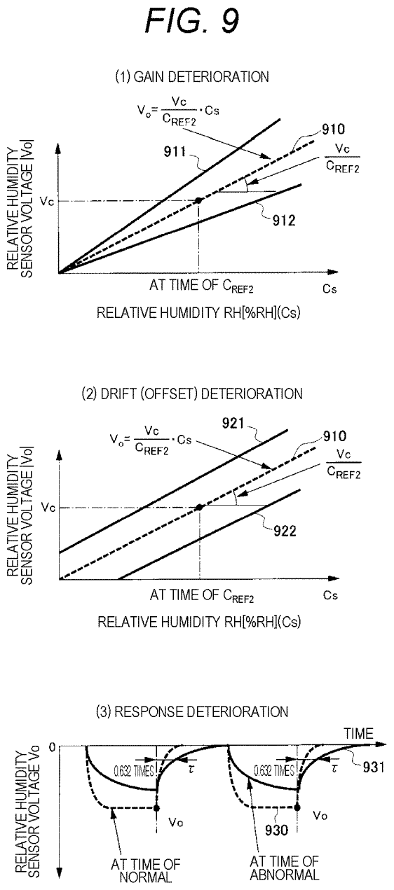

The deterioration of the humidity sensor 102 which can be detected by the humidity sensor diagnosis device 130 includes gain deterioration, drift (offset) deterioration, and response deterioration. These deteriorations will be described in detail with reference to FIGS. 8 and 9.

The diagnosis unit 110 includes a gain/drift diagnosis region determination unit 111, a gain/drift reference characteristic comparison unit 112, a reference capacitor switching determination unit 113, and a gain/drift determination unit 114. The diagnosis unit 110 includes a heater ON response deterioration diagnosis region determination unit 115, a heater ON response deterioration diagnosis time constant detection unit 116, and a heater ON response deterioration determination unit 117. Also, the diagnosis unit 110 includes a heater OFF response deterioration diagnosis region determination unit 118, a heater OFF response deterioration diagnosis time constant detection unit 119, and a heater OFF response deterioration determination unit 120. The gain/drift determination unit 114, the heater ON response deterioration determination unit 117, and the heater OFF response deterioration determination unit 120 constitute a normality/abnormality determination unit 121. Furthermore, the diagnosis unit 110 includes a correction unit 122 for each of controls of the humidity sensor.

The gain/drift diagnosis region determination unit 111 determines whether a state of the system (the internal combustion engine system in the embodiment) in which the humidity sensor 102 is used corresponds to the gain/drift diagnosis region in which the detection processing of gain deterioration or drift deterioration of the humidity sensor 102 can be performed. Also, the gain/drift diagnosis region determination unit 111 outputs the determination result to the reference capacitor switching determination unit 113 and the gain/drift reference characteristic comparison unit 112.

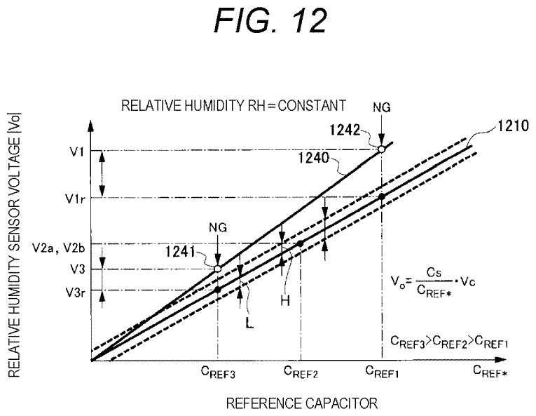

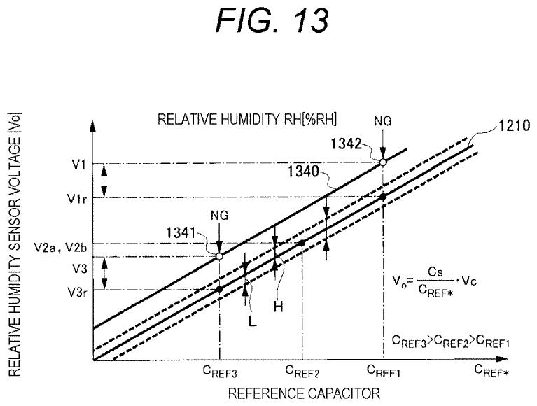

The gain/drift reference characteristic comparison unit 112 operates in the case in which the state of the target system corresponds to the gain/drift diagnosis region. The gain/drift reference characteristic comparison unit 112 compares the characteristic of the humidity sensor 102 with a normal reference characteristic based on an output voltage of the C-V conversion circuit 103 and outputs a comparison result (for example, an amount of deviation from the normal reference characteristic) to the gain/drift determination unit 114. Details will be described later with reference to FIGS. 12 and 13.

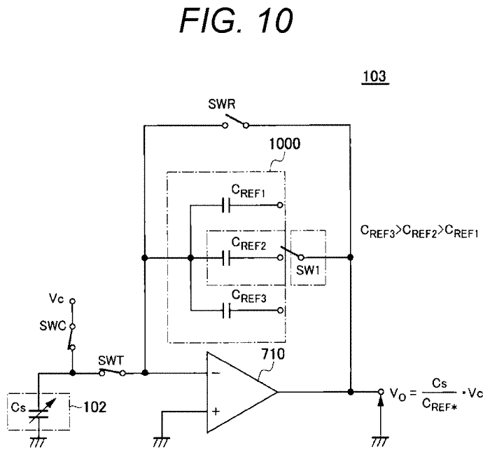

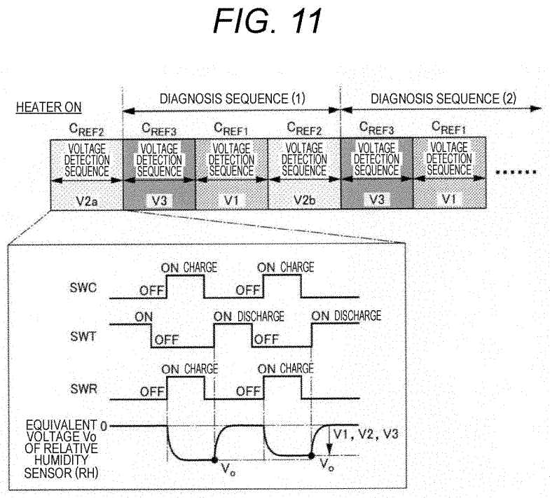

The reference capacitor switching determination unit 113 operates in the case in which the state of the target system corresponds to the gain/drift diagnosis region. The reference capacitor switching determination unit 113 determines a voltage detection sequence to be applied to the C-V conversion circuit 103 and outputs a command to switch the reference capacitor to the C-V conversion circuit 103 based on the determined voltage detection sequence (refer to FIGS. 10 and 11 which will be described later.).

The gain/drift determination unit 114 determines whether the gain or the drift of the humidity sensor 102 is normal or abnormal from the comparison result of the gain/drift reference characteristic comparison unit 112. Furthermore, the gain/drift determination unit 114 outputs the determination result to the heater ON response deterioration diagnosis region determination unit 115 and the heater OFF response deterioration diagnosis region determination unit 118.

The heater ON response deterioration diagnosis region determination unit 115 determines whether the state of the system (the internal combustion engine system in the embodiment) in which the humidity sensor 102 is used corresponds to the heater ON response deterioration diagnosis region (first response deterioration diagnosis region) in which the response deterioration detection processing when the heater of the humidity sensor 102 is turned on can be performed. The heater ON response deterioration diagnosis region determination unit 115 outputs the determination result to the heater ON response deterioration diagnosis time constant detection unit 116. The heater ON response deterioration diagnosis region determination unit 115 is an example of a first response deterioration diagnosis region.

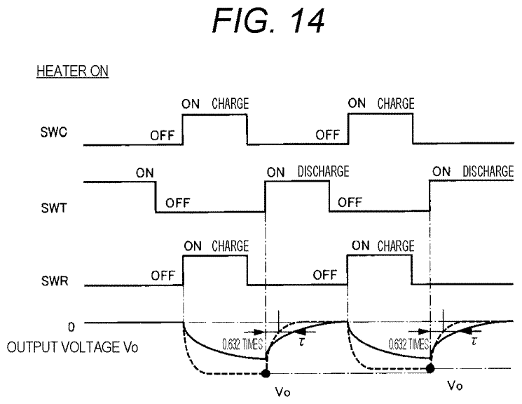

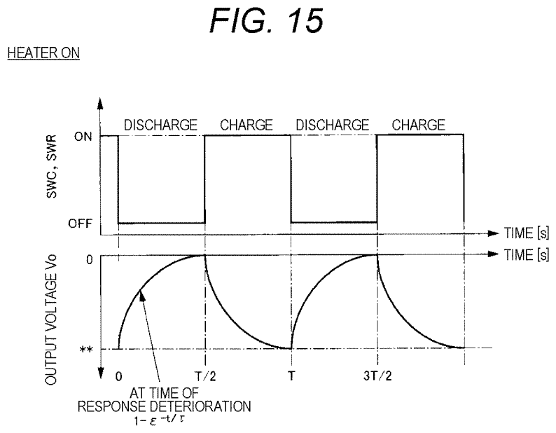

In the response deterioration diagnosis of the humidity sensor 102 when the heater is turned on, the heater ON response deterioration diagnosis time constant detection unit 116 calculates the reciprocal of the falling time constant of the output voltage at the time of charging and calculates the reciprocal of the rising time constant of the output voltage at the time of discharging based on the output voltage of the C-V conversion circuit 103. Details will be described later with reference to FIGS. 14 and 15 and the like.

The heater ON response deterioration determination unit 117 determines whether the responsiveness when the heater is turned on is normal or abnormal from the reciprocal of the falling time constant of the output voltage at the time of charging and the reciprocal of the rising time constant of the output voltage at the time of discharging detected by the heater ON response deterioration diagnosis time constant detection unit 116.

The heater OFF response deterioration diagnosis region determination unit 118 determines whether the state of the system (the internal combustion engine system in the embodiment) in which the humidity sensor 102 is used corresponds to the heater OFF response deterioration diagnosis region (second response deterioration diagnosis region) in which the response deterioration detection processing when the heater of the humidity sensor 102 is turned off can be performed. The heater OFF response deterioration diagnosis region determination unit 118 outputs the determination result to the heater OFF response deterioration diagnosis time constant detection unit 119. The heater OFF response deterioration diagnosis region determination unit 118 is an example of a second response deterioration diagnosis region.

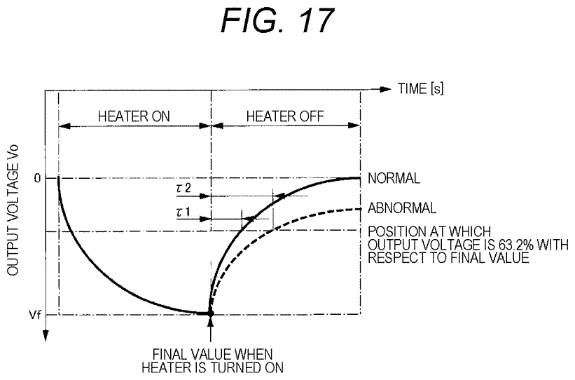

In the response deterioration diagnosis of the humidity sensor 102 when the heater 105 is switched from being turned on to being turned off, the heater OFF response deterioration diagnosis time constant detection unit 119 calculates a rising time constant of the output voltage when the heater is turned off based on the output voltage of the CV conversion circuit 103 and further take a reciprocal of a reciprocal of the rising time constant of the output voltage at the time of discharging when the heater is turned on to convert the rising time constant into a time constant (time constant conversion). Details will be described later with reference to FIG. 17 and the like.

The heater OFF response deterioration determination unit 120 compares the rising time constant of the output voltage when the heater is turned off with a value obtained by converting the rising time constant of the output voltage when the heater is turned on into a time constant and determines whether the responsiveness when the heater is turned off is normal or abnormal based on the comparison result.

The correction unit 122 corrects control in which accuracy can be improved by detecting humidity by the humidity sensor 102.

The above description includes an outline of the humidity detector 101 and the humidity sensor diagnosis device 130 according to the first embodiment of the present invention. In addition, an internal combustion engine system that is a target of the present invention and includes the humidity sensor 102 will be described below.

[Internal Combustion Engine System]

FIG. 2 shows an example of an internal combustion engine system in which the humidity sensor diagnosis device 130 is used. The internal combustion engine system 250 includes an internal combustion engine 240, an intake air system, and an exhaust air system and an ignition device 201, a fuel injection device 202, and a rotation speed detection device 203 are attached to the internal combustion engine 240. A flow rate of air flowing in from an intake air port through an air cleaner 200 is adjusted using a throttle valve 213, and then the flow rate is measured by a flow rate detection device 204.

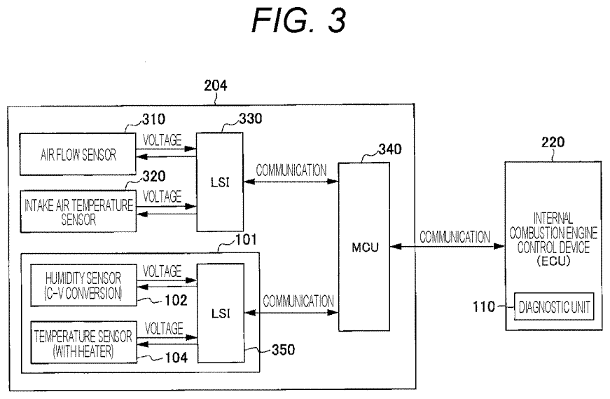

As illustrated in FIG. 3, the flow rate detection device 204 is a multifunctional detector (multi-sensor) into which an air flow sensor 310, an intake air temperature sensor 320, and a humidity detector 101 are built. Air flowing into an intake air pipe is mixed with a fuel injected from the fuel injection device 202 at a predetermined angle and supplied to each cylinder 214. An air-fuel ratio sensor 205 (an example of a pre-catalyst oxygen sensor), a three-way catalyst 206, and an oxygen sensor 215 (an example of a post-catalyst oxygen sensor) are mounted in the exhaust air system. The exhaust gas of the internal combustion engine 240 is purified using the three-way catalyst 206, and then discharged to the atmosphere.

The internal combustion engine control device 220 is a control device which controls the internal combustion engine system 250 by transmitting and receiving various signals and data to and from the internal combustion engine system 250 and an electronic control unit (ECU) is used as an example. The internal combustion engine control device 220 includes an analog input circuit 221, a digital input circuit 222, an A/D conversion circuit 223, an I/O unit 224, an MPU 225, a clock 226, a ROM 227, a RAM 228, a timer/counter 229, and an output circuit 230.

The micro-processing unit (MPU) 225 is a processor (control unit) which operates in synchronization with a clock signal output from the clock 226. The MPU 225 reads a control program stored in the ROM 227 into the RAM 228 and executes the control program. The timer/counter 229 measures time, the number of occurrences of a target event, and the like in accordance with an instruction from the MPU 225. In the case of detecting the abnormality of the diagnosis target in accordance with the control program, the MPU 225 turns on a warning lamp 235 provided on an instrument panel or the like. The function of each block of the humidity sensor diagnosis device 130 (FIG. 1) according to the embodiment is realized by the MPU 225 configured to execute the control program stored in the ROM.

The internal combustion engine control device 220 takes in an output signal Qa of the flow rate detection device 204 and a rotation speed Ne of a ring gear or a plate 208 using a rotation speed detection device 203, calculates a fuel injection amount Ti, and controls an amount of injection of the fuel injection device 202. The internal combustion engine control device 220 detects the air-fuel ratio in the internal combustion engine 240 from the air-fuel ratio sensor 205 and performs air-fuel ratio feedback control to correct the fuel injection amount Ti so that the air-fuel ratio in the internal combustion engine 240 becomes the theoretical air-fuel ratio. In addition, the internal combustion engine control device 220 detects the air-fuel ratio after the catalyst using the oxygen sensor 215.

On the other hand, the fuel in the fuel tank 209 is sucked and pressurized by the fuel pump 210, and then guided to a fuel inlet of the fuel injection device 202 through a fuel pipe 212 including a pressure regulator 211, and the excess fuel returns to the fuel tank 209. The configuration of the internal combustion engine system 250 to which the humidity sensor diagnosis device 130 is applied has been described above.

The humidity sensor which measures the humidity of the intake air system is exposed to the intake air, contaminants flow into the element (polymer sensitive film) of the humidity sensor, and detection accuracy deteriorates or the humidity sensor itself deteriorates. Under such an environment, if a configuration for realizing a diagnostic function is provided in the humidity sensor itself, the diagnostic function is also likely to deteriorate. Therefore, as a result of repeated studies, the inventors of the present application have arrived at a method capable of diagnosing a humidity sensor while preventing deterioration of a diagnostic function described in the specification and the accompanying drawings of the present application.

The humidity sensor diagnosis device 130 will be specifically described below.

FIG. 3 is a block diagram illustrating a configuration example of the flow rate detection device 204 (multifunction sensor) including a general humidity sensor (relative humidity sensor). In the embodiment, it is assumed that a relative humidity sensor is used as the humidity sensor 102. The relative humidity (RH) is expressed by a ratio (%) of an actual water vapor amount (water vapor pressure) to a saturated water vapor amount (saturated water vapor pressure).

As described above, the flow rate detection device 204 has the humidity detector 101 including the air flow sensor 310, the intake air temperature sensor 320, and the humidity sensor 102 built thereinto. The flow rate detection device 204 includes a large-scale integration (LSI) 330 and a micro-control unit (MCU) 340. The air flow sensor 310 is a sensor which measures a flow rate of the air in the intake air system and the intake air temperature sensor 320 is a sensor which measures a temperature of the air in the intake air system. Also, the humidity sensor 102 is a sensor which measures humidity of the air in the intake air system.

The air flow sensor 310 and the intake air temperature sensor 320 output voltages to the LSI 330 as respective detection results. In addition, the humidity sensor 102 (C-V conversion circuit 103) and the temperature sensor 104 output voltages to the LSI 350 as respective detection results. Furthermore, each of the LSI 330 and the LSI 350 transmits data corresponding to the received voltage to the internal combustion engine control device 220 including the diagnosis unit 110 via the MCU 340. Although detailed description is omitted, the LSI 330 and the LSI 350 appropriately include a circuit which processes the voltage input from each sensor, for example, a sampling circuit, a noise removal circuit, an amplifier circuit, and the like.

The diagnosis unit 110 of the internal combustion engine control device 220 diagnoses the humidity sensor 102 based on the detection results of the humidity sensor 102 and the temperature sensor 104. In addition, the diagnosis unit 110 outputs a command to switch a reference capacitor illustrated in FIG. 10 which will be described later to the LSI 350 via the MCU 340 and switches the reference capacitor of the C-V conversion circuit 103 using the LSI 350.

[Structure of Humidity Sensor]

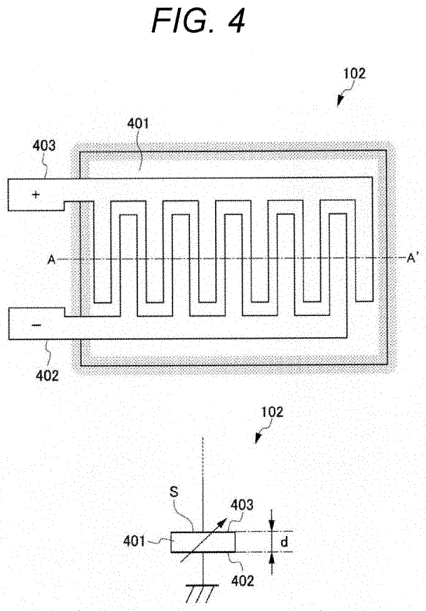

FIG. 4 illustrates an exemplary structure of the humidity sensor 102 using capacitance. The structure of the humidity sensor 102 illustrated in FIG. 4 is a known structure. As illustrated in the upper side of FIG. 4, the humidity sensor 102 is configured using a moisture-sensitive film 401 as an example. Inside the moisture-sensitive film 401, a comb-shaped positive electrode 403 and a comb-shaped negative electrode 402 are provided and the positive electrode 403 and the negative electrode 402 are disposed in a state in which one comb-shaped tooth meshes with the other comb-shaped tooth. For the moisture-sensitive film 401, polyimide (relative permittivity ε′=3) or the like is used.

If the humidity of the environment changes, the relative permittivity (ε′=80) of water affects the moisture-sensitive film 401 (relative permittivity ε′=3 of polyimide), the relative permittivity ε′ of the moisture-sensitive film 401 changes, and capacitance C relating to the humidity changes. As illustrated in the lower diagram of FIG. 4, an equivalent circuit of the humidity sensor 102 has a structure equivalent to that of a parallel plate capacitor. That is to say, the capacitance C can be expressed by Expression (1):

$$C = {ε}^{′} \cdot {ε}_{0} \frac{S}{d} \qquad ( 1 )$$

ε₀: dielectric constant in vacuum=8.854×10⁻¹² [F/m]

ε′: relative permittivity which is one of electrical characteristics of substance

(The dielectric constant of substance is obtained through multiplication by ε₀.)

S: surface area, d: gap length, C: capacitance.

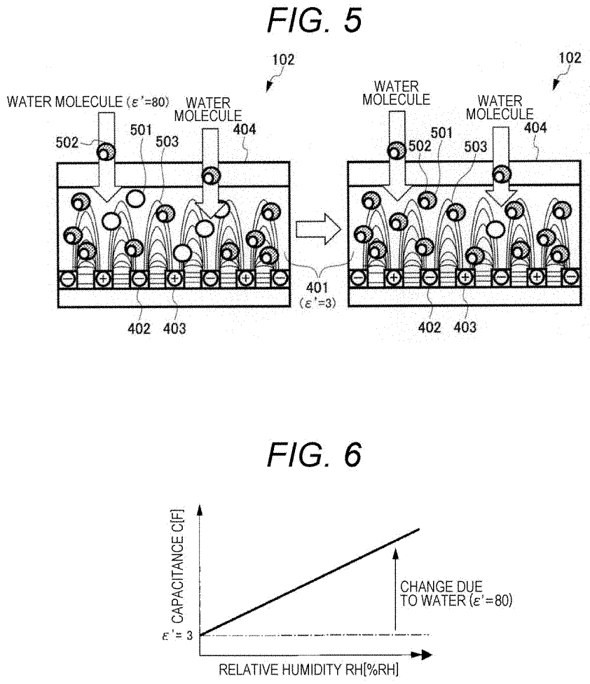

FIG. 5 is a diagram for explaining the principle of the humidity sensor and illustrates a cross section taken along line A-A′ on the upper side of FIG. 4. Surfaces (an upper surface and a lower surface in FIG. 5) of the moisture-sensitive film 401 are covered with a protective film 404. The moisture-sensitive film 401 is porous and a great number of polymer pores 501 are formed therein. Portion of the positive electrode 403 and the negative electrode 402 are alternately arranged inside the moisture-sensitive film 401. When the power supply is turned on, lines for electric power are generated between the positive electrode 403 and the negative electrode 402. In the humidity sensor 102, if water molecules 502 pass through the protective film 404 and are incorporated into the moisture-sensitive film 401, the water molecules 502 enter the polymer pore 501, the relative permittivity ε′ of the moisture-sensitive film 401 changes, and as a result, the capacitance C of the humidity sensor 102 increases.

FIG. 6 is a graph for describing an example of a relationship between the relative humidity RH [% RH] and the capacitance C [F] of the humidity sensor. It can be seen from FIG. 6 that, if the relative humidity increases under the influence of the relative permittivity of water (ε′=80), the capacitance of the humidity sensor also increases linearly.

[C-V Conversion Circuit in the Related Art]

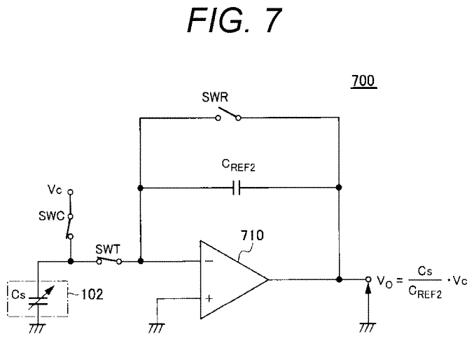

FIG. 7 illustrates a C-V conversion circuit which outputs a voltage in accordance with the capacitance of a humidity sensor in the related art.

A positive electrode side of the humidity sensor 102 is connected to an inverting input terminal of an operational amplifier 710 via a switch SWT, and a negative electrode side thereof is grounded. A capacitor Cs is an equivalent capacitor (capacitance) of the humidity sensor 102 and will be described as an “equivalent capacitor Cs” below. In addition, a connection midpoint between a positive electrode side of the humidity sensor 102 and the switch SWT is connected to a power supply Vc via a switch SWC. A reference capacitor C_{REF2} and a switch SWR are connected in parallel to an output terminal and an inverting input terminal of the operational amplifier 710, respectively. The reference capacitor C_{REF2} has capacitance (hereinafter, the capacitance is also referred to as a “reference capacitance”) serving as a reference at the time of humidity detection. A non-inverting input terminal of the operational amplifier 710 is grounded.

A voltage applied to the output terminal of the operational amplifier 710 is taken out as an output voltage Vo of the C-V conversion circuit 700 and output to the LSI 350. Since the output voltage Vo changes in accordance with the capacitance of the equivalent capacitor Cs, it can be said to be the “equivalent voltage” of the humidity sensor 102.

At the time of charging, the C-V conversion circuit 700 turns on the switch SWC, turns off the switch SWT, and turns on the switch SWR to charge the equivalent capacitor Cs with electric charges. On the other hand, at the time of discharging, the C-V conversion circuit 700 turns off the switch SWC, turns on the switch SWT, and turns off the switch SWR, discharges the charge to the equivalent capacitor Cs, and outputs the output voltage Vo. The state at this time can be expressed by Expression (2). Here, the output voltage Vo has a negative value.

$$Vo = ( \frac{1}{{C}_{REF 2}} ) / ( \frac{1}{Cs} ) \cdot Vc = \frac{Cs}{{C}_{REF 2}} \cdot Vc \qquad ( 2 )$$

[Deterioration Mode]

FIG. 8 is a diagram for examining a factor of deterioration (deterioration mode) of the humidity sensor. The deterioration is particularly caused due to poisoning of a volatile organic compound (VOC) or the like. The deterioration caused by the poisoning is mainly considered to be gain deterioration, response deterioration, and drift (offset) deterioration. Therefore, the humidity sensor diagnosis device 130 according to the present invention detects these three types of deterioration. Each deterioration will be briefly described.

[Gain Deterioration]

If the relative humidity sensor (humidity sensor 102) deteriorates, a certain inclination occurs between the detected humidity of the relative humidity sensor and the actual humidity, which may be an error in the output of the relative humidity sensor or a response deterioration of the relative humidity sensor. When the causes of the deterioration are errors in the output of the relative humidity sensor, it is necessary to detect these through diagnosis in the case in which the inclination is excessively large or excessively small.

[Response Deterioration]

When the cause of deterioration is response deterioration of the relative humidity sensor, the response deterioration is detected.

[Drift (Offset) Deterioration]

In the case in which the poisoning characteristic is not only the first-order inclination (characteristic having an intercept), deterioration in which the characteristic is offset due to poisoning is detected. It has been confirmed before poisoning (before use of the humidity sensor) that there is no offset in the original characteristics of the relative humidity sensor.

Note that the three types of deterioration described above can be represented by the diagram illustrated in FIG. 9.

FIG. 9 is a graph for describing gain deterioration, drift (offset) deterioration, and response deterioration. In the graph of (1) gain deterioration on the upper side of FIG. 9 and (2) drift (offset) deterioration on a center of FIG. 9, a horizontal axis represents the relative humidity RH (capacitance of the equivalent capacitor Cs), and a vertical axis represents an absolute value of an output voltage Vo of the C-V conversion circuit 700. Also, in the graph of (3) response deterioration on the lower side of FIG. 9, a horizontal axis represents time, and a vertical axis represents a relative humidity sensor voltage Vo.

As illustrated in the upper part of FIG. 9, the inclination of a normal reference characteristic 910 of the relative humidity sensor indicated by a broken line is VC/C_{REF2}. If gain deterioration occurs, this inclination changes. If the inclination is excessively large, the relative humidity sensor has a characteristic 911, and if the inclination is excessively small, the relative humidity sensor has a characteristic 912.

As illustrated in the center of FIG. 9, if drift deterioration occurs, the intercept changes (is offset) while the inclination remains constant. If the output voltage |Vo| is offset in an increasing direction, the relative humidity sensor has a characteristic 921, and if the output voltage |Vo| is offset in a decreasing direction, the relative humidity sensor has a characteristic 922.

On the lower side of FIG. 9, the relative humidity sensor (output voltage Vo) is periodically turned on and off repeatedly. The behavior of the output voltage Vo of the relative humidity sensor at the time of the normal state is indicated as a response characteristic 930 indicated by a broken line. Here, if the response deterioration (abnormality) occurs, since the behavior of the output voltage Vo of the relative humidity sensor has a slow response speed as indicated by a solid-line response characteristic 931, a time (time constant τ) until the output voltage Vo reaches about 63.2% of a final target value becomes longer than that at the time of the normal state. The lower side of FIG. 9 shows an example of response deterioration with respect to the rise and fall of the output voltage.

[C-V Conversion Circuit]

A configuration of a C-V conversion circuit which is a feature of the present invention will be described below.

FIG. 10 illustrates an example of the C-V conversion circuit provided in the humidity sensor diagnosis device 130. The C-V conversion circuit 103 illustrated in FIG. 10 includes a capacitor parallel circuit 1000 and a switch SW1 instead of the reference capacitor C_{REF2} of the C-V conversion circuit 700 illustrated in FIG. 7. That is to say, a circuit in which the capacitor parallel circuit 1000 and the switch SW1 are connected in series is connected in parallel between an inverting input terminal and the output terminal of the operational amplifier 710.

In the capacitor parallel circuit 1000, a plurality of reference capacitors C_{REF1} to C_{REF3} having different pieces of reference capacitance are connected in parallel. In the embodiment, the magnitude of the reference capacitance is set in the order of C_{REF3}>C_{REF2}>C_{REF1} The switch SW1 is switched to be connected to any one of the reference capacitors C_{REF1} to C_{REF3}. The switches SWC, SWT, and SWR and the switch SW1 are driven using a switch control signal from the internal combustion engine control device 220.

As described above, in order to detect gain deterioration and drift (offset) deterioration, a plurality of reference capacitors C_{REF*} (* is 1, 2, or 3 in FIG. 10) is prepared and these reference capacitors C_{REF*} can be switched by the switch SW1. At this time, the output voltage Vo of the C-V conversion circuit 103 is expressed by Expression (3).

$$Vo = \frac{Cs}{{C}_{REF *}} \cdot Vc \qquad ( 2 )$$

As understood from the Expression (3) described above, in the C-V conversion circuit 103, the denominator of the Expression (2) described in FIG. 7 can be changed. Making the denominator variable means changing a measurement point (reference capacitor C_{REF*}) on a horizontal axis in FIGS. 12 and 13 which will be described later. Note that, although the three reference capacitors C_{REF1} to C_{REF3} are provided in the embodiment, C_{REF2} may be omitted and two reference capacitors may be provided, or four or more reference capacitors may be provided.

[Diagnosis Sequence]

FIG. 11 illustrates an example of a diagnosis sequence using the C-V conversion circuit 103.

As illustrated in FIG. 11, after turning on the heater 105, the diagnosis unit 110 performs a diagnosis sequence using the C-V conversion circuit 103. In one diagnosis sequence, the diagnosis unit 110 switches the reference capacitor C_{REF*} and obtains the output voltage Vo corresponding to the reference capacitor C_{REF*}. For example, in the first diagnosis sequence (1), the diagnosis unit 110 first performs a sub-sequence (voltage detection sequence) for detecting the output voltage Vo at the time of switching to the reference capacitor C_{REF3}. Subsequently, the diagnosis unit 110 detects the output voltage Vo at the time of switching to the reference capacitor C_{REF2} and detects the output voltage Vo at the time of finally switching to the reference capacitor C_{REF2}. After the first diagnosis sequence (1) ends, the second diagnosis sequence (2) is similarly performed.

In the present specification, if the reference capacitor is C_{REF1}, the output voltage Vo detected at that time is V1. Also, if the reference capacitor is C_{REF2}, the output voltage Vo at that time is V2 (V2a or V2b). A difference between V2a and V2b will be separately described. Furthermore, if the reference capacitor is C_{REF3}, the output voltage Vo at that time is V3.

Note that, as will be described later with reference to FIG. 12, the voltage detection sequence (V2a, V2b) at the time of switching to the reference capacitor C_{REF2} can be omitted.

[Method of Detecting Gain Deterioration]

FIG. 12 is a graph illustrating a method of detecting gain deterioration using the humidity sensor diagnosis device 130. FIG. 12 illustrates an example in which a poisoning substance IPA (ε′=18) flows into the humidity sensor 102. In FIG. 12, a horizontal axis represents a reference capacitor (C_{REF*}) and a vertical axis represents an absolute value of the output voltage Vo of the C-V conversion circuit 103. As a precondition of FIG. 12 and FIG. 13 which will be described later, it is assumed that the relative humidity RH [% RH] of the intake air is kept constant.

(Gain Normality)

First, the diagnosis unit 110 switches the reference capacitor of the C-V conversion circuit 103 to C_{REF2} and sets the output voltage Vo detected at this time to V2a. Subsequently, the diagnosis unit 110 switches the reference capacitor to C_{REF3} and sets the output voltage Vo at that time to V3. Subsequently, the diagnosis unit 110 sets the output voltage Vo obtained from the normal reference characteristic 1210 to V3r when the reference capacitor is C_{REF3}. In addition, the diagnosis unit 110 compares V3 with V3r and determines whether V3 is within the range of an upper limit margin H and a lower limit margin L with respect to V3r.

Here, if V3≈V3r, that is, V3 is within the range of the upper limit margin H and the lower limit margin L with respect to V3r, the diagnosis unit 110 then switches the reference capacitor to C_{REF1} and sets the output voltage Vo at that time to V1. Subsequently, when the reference capacitor is C_{REF1}, the diagnosis unit 110 sets the output voltage Vo obtained from the normal reference characteristic 1210 to V1r. Furthermore, the diagnosis unit 110 compares V1 with V1r and determines whether V1 is within the range of the upper limit margin H and the lower limit margin L with respect to V1r.

Here, if V1≈V1r, that is, V1 is within the range of the upper limit margin H and the lower limit margin L with respect to V1r, the diagnosis unit 110 then switches the reference capacitor to C_{REF2} and sets the output voltage Vo at that time to V2b. Thereafter, the diagnosis unit 110 compares V2b detected this time with V2a detected last time and determines whether V2b is within the range of the upper limit margin H and the lower limit margin L with respect to V2a. In addition, if V2b≈V2a, that is, V2b is within the range of the upper limit margin H and the lower limit margin L with respect to V2a, the diagnosis unit 110 can determine that the humidity is constant, and thus determines that the gain is normal.

(Gain Abnormality)

On the other hand, the gain abnormality can be detected as follows. First, the diagnosis unit 110 sets the output voltage Vo when the reference capacitor is C_{REF2} to V2a. Furthermore, the reference capacitor is switched to C_{REF3} and the output voltage Vo at that time is set to V3. At this time, if the output voltage Vo obtained from the normal reference characteristic 1210 is V3r and V3≠V3r (there is a difference exceeding the upper and lower limit margins), it is determined that the gain is abnormal. For example, since a measurement point 1241 on a measured characteristic 1240 exceeds the upper limit margin H, it is determined as abnormal (NG).

Similarly, the diagnosis unit 110 switches the reference capacitor to C_{REF1} and sets the output voltage Vo at that time to V1. At this time, if the output voltage obtained from the normal reference characteristic 1210 is V1r and V1≠V1r (there is a difference exceeding the upper and lower limit margins), it is determined that the gain is abnormal. For example, since a measurement point 1242 on the measured characteristic 1240 also exceeds the upper limit margin H, it is determined to be abnormal (NG).

Similarly, the diagnosis unit 110 switches the reference capacitor to C_{REF2} and sets the output voltage Vo at that time to V2b. Also, if V2b≠V2a (there is a difference exceeding the upper and lower limit margins), it is determined that the gain is abnormal.

As described above, in the case in which the reference capacitor C_{REF*} is changed in a state in which the humidity (the output voltage Vo under the same condition) is within a certain range, if there is at least one output voltage Vo exceeding the upper limit margin H or falling below the lower limit margin L, it is determined that the gain deteriorates. The upper limit margin H and the lower limit margin L can be set to appropriate values in accordance with the intake air temperature measured by the intake air temperature sensor 320.

Note that, as a method of confirming that the humidity during diagnosis is in a state in which the humidity is within a certain range, the output voltage Vo may be measured a plurality of times by switching to the reference capacitor C_{REF3} or C_{REF1} instead of the reference capacitor C_{REF2} and it may be determined whether the difference between the plurality of output voltages Vo is within a certain range. For example, in one diagnosis sequence (FIG. 11), switching to the reference capacitor C_{REF3} is performed twice and it is confirmed whether the difference between the two output voltages Vo (V3a, V3b) falls within the range of the upper limit margin H and the lower limit margin L. The method of confirming that the humidity during the diagnosis is in a certain range is similar to the method of detecting drift (offset) deterioration.

In addition, in order to confirm that the humidity during diagnosis is within a certain range, the reference capacitor is switched to C_{REF2}, V2a and V2b are measured as the output voltage Vo and the two values are compared. Here, this processing may be omitted. The reason is that, since an interval of measuring V2a and V2b is very short, it is not usually assumed that the humidity changes so much as to affect the diagnosis result during that time. This simplifies the procedure of diagnosis.

[Method of Detecting Drift (Offset) Deterioration]

FIG. 13 is a graph for describing a method of detecting drift (offset) deterioration using the humidity sensor diagnosis device 130. FIG. 13 illustrates an example in which the poisoning substance IPA (ε′=18) flows into the humidity sensor 102. In FIG. 13, a horizontal axis represents a reference capacitor (C_{REF*}) and a vertical axis represents an absolute value of the output voltage Vo of the C-V conversion circuit 103.

As shown in FIG. 13, the drift (offset) deterioration indicates a deterioration state in which the inclination is the same as that of the normal reference characteristic 1210 and the offset (intercept) is present. The drift (offset) detection method is basically the same as the gain deterioration detection method illustrated in FIG. 12. For this reason, although it is not possible to discriminate and detect the gain deterioration and the drift (offset) deterioration, it is possible to determine normality or abnormality as one of the characteristic abnormalities.

For example, although the inclination of the measured characteristic 1240 is the same as that of the normal reference characteristic 1210 in FIG. 13, the measurement point 1341 on the characteristic 1340 exceeds the upper limit margin H. Thus, it is determined to be abnormal (NG). Similarly, the measurement point 1342 on the characteristic 1340 is also determined to be abnormal (NG) because the point exceeds the upper limit margin H.

As described above, also in the diagnosis of drift (offset) deterioration, in the case in which the reference capacitor C_{REF*} is changed in a state in which the humidity (output voltage Vo under the same condition) is within a certain range, if there is at least one output voltage Vo exceeding the upper limit margin H or falling below the lower limit margin L, it is determined to be gain deterioration. The upper limit margin H and the lower limit margin L can be set to appropriate values in accordance with the intake air temperature measured by the intake air temperature sensor 320.

[Method of Detecting Response Deterioration]

A method of detecting response deterioration of the temperature sensor using the humidity sensor diagnosis device 130 will be described below.

The response deterioration is detected differently between when the heater is turned on and when the heater is turned off. FIG. 14 is a timing chart for describing an example of a response deterioration behavior of the humidity sensor 102 when the heater is turned on. In FIG. 14, timings of the switch SWC, the switch SWT, the switch SWR, and the output voltage Vo (equivalent voltage) are illustrated. The details of the timing chart of FIG. 14 include the details described in the lower side of FIG. 9 and FIG. 11 and a broken line indicates a response characteristic at the time of a normal state and a solid line indicates a response characteristic at the time of response deterioration.

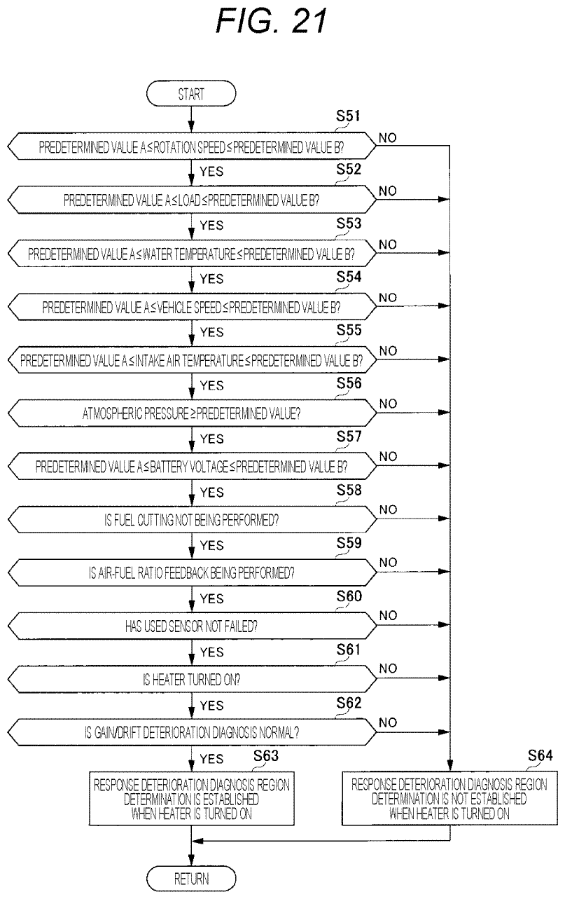

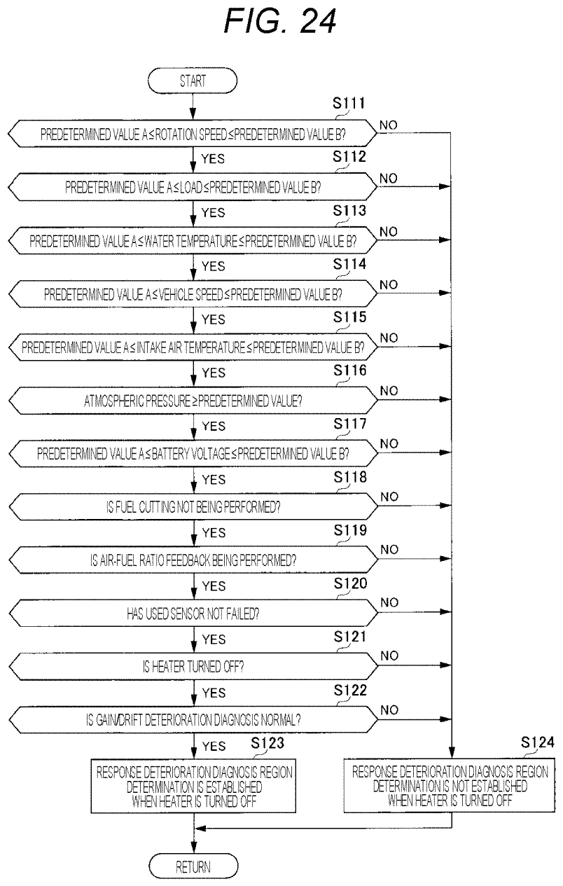

A response deterioration of a fall of the output voltage Vo during charging and a response deterioration of a rise of the output voltage Vo during discharging are detected. When gain deterioration or drift (offset) deterioration occurs, humidity according to the environment cannot be detected, and thus a response deterioration diagnosis is not performed (refer to FIGS. 21 and 24 which will be described later). When both of the gain and the drift (offset) are normal, the response deterioration diagnosis is performed. The reason why the response deterioration is detected is that, in the case in which the time constant of the output voltage Vo is very long, charging and discharging may be switched before the voltage reaches the voltage corresponding to the humidity according to the environment and the correct humidity may not be detected.

FIG. 15 illustrates a method of detecting response deterioration of the humidity sensor when the heater is turned on using the humidity sensor diagnosis device 130. FIG. 15 illustrates timings of the switches SWC and SWR and the output voltage Vo.

In the case in which the response deterioration of the output voltage Vo is the first-order lag response, Expression (4) for the response deterioration index is established in the response deterioration at the time of discharging. The expression in the parentheses “( )” corresponds to the output voltage Vo. During discharging, a rising time constant is detected.

$$\begin{matrix}Response deterioration index = {\int }_{0}^{\frac{T}{2}} {\{ \frac{d}{dt} ( 1 - {ε}^{- \frac{t}{τ}} ) \}}^{2} dt \\ = \frac{1}{2 τ} ( 1 - {ε}^{- T / τ} )\end{matrix} \qquad ( 4 )$$

Since T>τ is established in Expression (4), Expression (5) is established.

$$Response deterioration index = \frac{1}{2 τ} ∝ \frac{1}{τ} \qquad ( 5 )$$

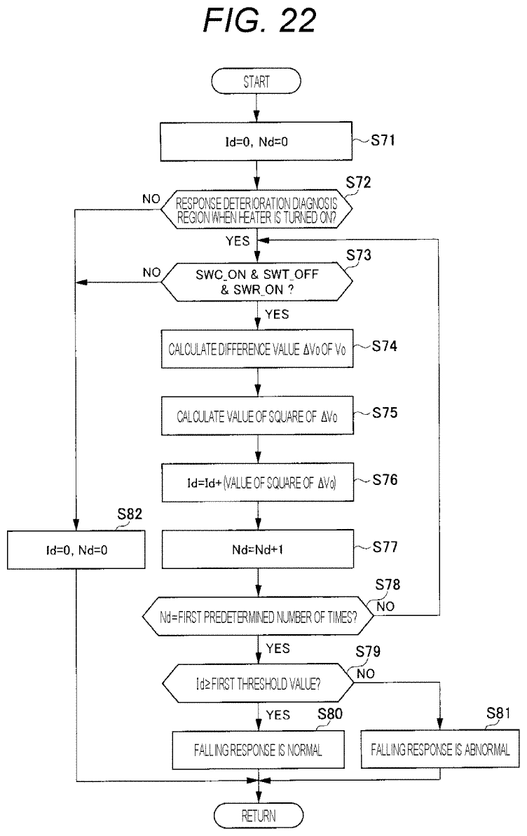

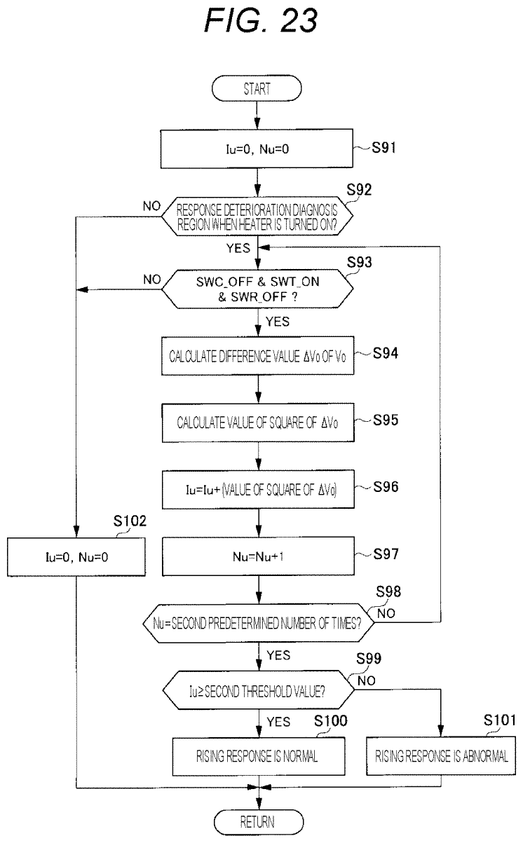

That is to say, the response deterioration index is a parameter inversely proportional to the time constant τ of the response speed. Basically, the case of charging is the same as the case of discharging and the response deterioration index is inversely proportional to the time constant τ. During discharging, a falling time constant is detected. As will be described later, in FIG. 22, the falling response deterioration index is Id, and in FIG. 23, the rising response deterioration index is Iu.

[Detection Result of Response Deterioration when Heater is Turned On]

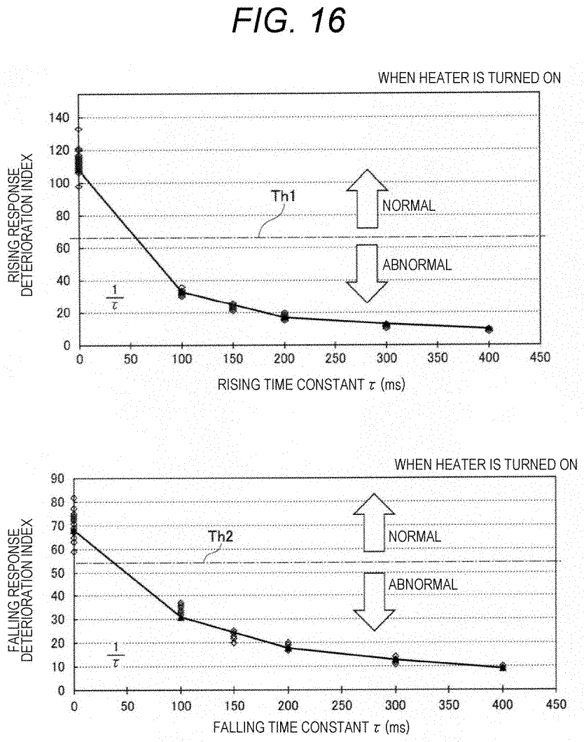

FIG. 16 illustrates a detection result example of response deterioration of the humidity sensor when the heater is turned on using the humidity sensor diagnosis device 130. This detection result is a simulation result for a humidity sensor under a certain condition.

The upper diagram of FIG. 16 illustrates a relationship between a rising response deterioration index and a rising time constant τ when a response deteriorates due to poisoning when the heater is turned on. It can be seen that the detection result of the response deterioration shown in the upper diagram of FIG. 16 is a result at the time of discharging and the rising response deterioration index is inversely proportional to the time constant. Therefore, a threshold value Th1 for determining that the rising response is abnormal is set, and in the case in which the rising response deterioration index is equal to or greater than the threshold value, it is determined to be normal, and in the case in which the rising response deterioration index is less than the threshold value, it is determined to be abnormal. A region determined to be abnormal indicates a state in which the time constant is long. Note that, the threshold value may be set as a table (lookup table) of intake air temperatures having a high relationship with humidity. That is to say, it is preferable to make the threshold value variable in accordance with the intake air temperature measured by the intake air temperature sensor 320.

The lower diagram of FIG. 16 illustrates a relationship between a falling time constant τ and a falling response deterioration index when a response deteriorates due to poisoning when the heater is turned on. The deterioration detection using the falling response deterioration index is also similar to the case of the falling response deterioration index. That is to say, the falling response deterioration index is inversely proportional to the time constant. A threshold value Th2 for determining that the falling response is abnormal is set, and in the case in which the falling response deterioration index is equal to or greater than the threshold value, it is determined to be normal, and in the case in which the falling response deterioration index is less than the threshold value, it is determined to be abnormal. In the case of falling, response deterioration is detected during charging.

The above description includes a method of detecting response deterioration when the heater is turned on. A method of detecting response deterioration when the heater is changed from being turned-on to being turned-off will be described below.

[Detection Result of Response Deterioration when Heater is Turned Off]

FIG. 17 illustrates a method of detecting response deterioration of the humidity sensor when the heater is turned off using the humidity sensor diagnosis device 130. As illustrated in FIG. 17, the detection of the response deterioration when the heater is turned off is to detect the response deterioration immediately after the heater 105 is changed from being turned-on to being turned-off. In this case, the time constant when the heater is turned off is directly measured. The time until the output voltage Vo rises to 0.632 times the final value Vf when the heater is turned off with respect to the final value Vf of the output voltage Vo when the heater is turned on is measured. In other words, when the final value “Vf” is 0% and the output voltage “0” is 100%, it is time for the output voltage Vo to reach a voltage corresponding to 0% to 63.2%. This time is a time constant when the heater is turned off. As illustrated in FIG. 17, the time constant τ2 at the time of the response abnormality is larger than the time constant τ1 at the time of the normal response.

Since the response deterioration index when the heater is turned on is the reciprocal of the time constant, the time constant when the heater is turned on can be obtained by obtaining the reciprocal of the response deterioration index when the heater is turned on. The heater ON time constant is compared with the measured heater OFF time constant. If the two time constants are equal to each other, it is determined to be normal, and in the case in which the heater OFF time constant is longer than the heater ON time constant, it is determined to be abnormal.

[Absolute Humidity]

Methods of detecting gain deterioration, drift (offset) deterioration, and response deterioration with respect to the relative humidity RH have been described above. However, in practice, it is necessary to detect a deterioration state of the absolute humidity. The absolute humidity SH can be expressed by Expression (6):

SH=0.662×1000×E/(P−E) (6)

Water vapor pressure E=RH×EW/100 [kPa]

Saturated water vapor pressure EW=α×exp (β×T/(λ+T)) [kPa]

α: 0.6112, β: 17.62, λ: 243.5

0.662: Molecular weight of water/molecular weight of dry air

RH: relative humidity [% RH], T: temperature [° C.], P: atmospheric pressure [kPa]

If gain deterioration, drift (offset) deterioration, or response deterioration occurs with respect to the relative humidity RH, as a result, a similar deterioration state also occurs in the absolute humidity SH. Therefore, by detecting each abnormality with respect to the relative humidity RH, it is possible to detect gain deterioration, drift (offset) deterioration, and response deterioration of the absolute humidity SH.

A procedure of performing processing using each block of the humidity sensor diagnosis device 130 (refer to FIG. 1) will be described below.

[Gain/Drift Diagnosis Region Determination Processing]

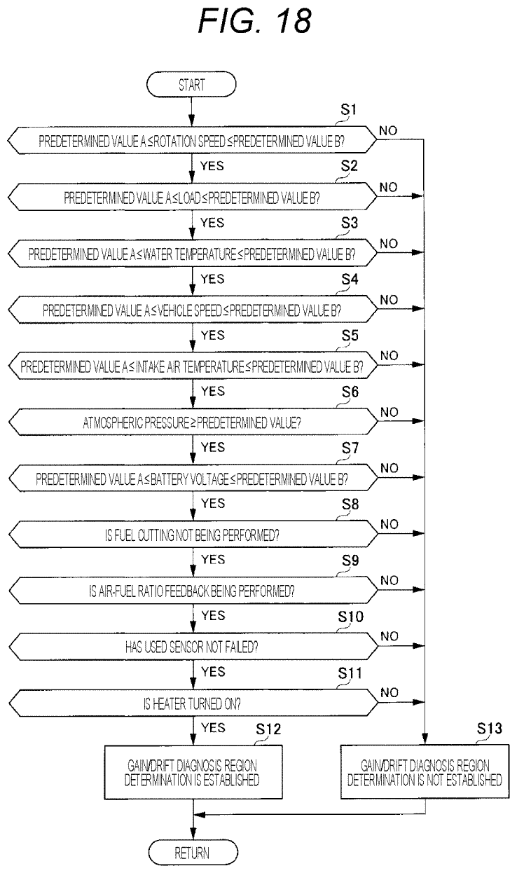

FIG. 18 is a flowchart for describing a procedure example of gain/drift diagnosis region determination processing using the gain/drift diagnosis region determination unit 111. Each step of FIG. 18 illustrates a diagnosis region determination condition in the gain/drift diagnosis.

First, in Step S1, the gain/drift diagnosis region determination unit 111 checks whether a rotation speed of the internal combustion engine 240 is within a predetermined range (predetermined value A≤rotation speed≤predetermined value B). In the case in which the rotation speed is within the predetermined range (YES in S1), the process proceeds to the process of Step S2, and in the case in which the rotation speed is not within the predetermined range (NO in S1), the process proceeds to the process of step S13.

Subsequently, in Step S2, the gain/drift diagnosis region determination unit 111 checks whether a load of the internal combustion engine 240 is within a predetermined range (predetermined value A≤load≤predetermined value B). In the case in which the load is within the predetermined range (YES in S2), the process proceeds to the process of Step S3, and in the case in which the load is not within the predetermined range, the process proceeds to the process of Step S13 (NO in S2). The load of the internal combustion engine 240 can be obtained as, for example, a ratio between an air flow rate and a rotational speed or a rotational torque.

Subsequently, in Step S3, the gain/drift diagnosis region determination unit 111 checks whether a temperature (water temperature) of cooling water is within a predetermined range (predetermined value A≤water temperature≤predetermined value B). In the case in which the water temperature is within the predetermined range (YES in S3), the process proceeds to the process of Step S4, and in the case in which the water temperature is not within the predetermined range (NO in S3), the process proceeds to the process of Step S13.

Subsequently, in Step S4, the gain/drift diagnosis region determination unit 111 checks whether a vehicle speed is within a predetermined range (predetermined value A≤vehicle speed≤predetermined value B). In the case in which the vehicle speed is within the predetermined range (YES in S4), the process proceeds to the process of Step S5, and in the case in which the vehicle speed is not within the predetermined range (NO in S4), the process proceeds to the process of Step S13.

Subsequently, in Step S5, the gain/drift diagnosis region determination unit 111 checks whether an intake air temperature is within a predetermined range (predetermined value A≤intake air temperature≤predetermined value B). In the case in which the intake air temperature is within the predetermined range (YES in S5), the process proceeds to the process of Step S6, and in the case in which the intake air temperature is not within the predetermined range (NO in S5), the process proceeds to the process of Step S13.

Subsequently, in Step S6, the gain/drift diagnosis region determination unit 111 checks whether an atmospheric pressure is equal to or higher than a predetermined value (atmospheric pressure≤predetermined value). In the case in which the atmospheric pressure is within the predetermined range (YES in S6), the process proceeds to the process of Step S7, and in the case in which the atmospheric pressure is not within the predetermined range (NO in S6), the process proceeds to the process of Step S13.

Subsequently, in Step S7, the gain/drift diagnosis region determination unit 111 checks whether a battery voltage is within a predetermined range (predetermined value A≤battery voltage≤predetermined value B). In the case in which the battery voltage is within the predetermined range (YES in S7), the process proceeds to the process of Step S8, and in the case in which the battery voltage is not within the predetermined range (NO in S7), the process proceeds to the process of Step S13.

Subsequently, in Step S8, the gain/drift diagnosis region determination unit 111 checks whether fuel cutting is being performed. In the case in which the fuel cutting is not being performed (YES in S8), the process proceeds to the process of Step S9. In the case in which the fuel cutting is being performed (NO in S8), the process proceeds to the process of Step S13.

Subsequently, in Step S9, the gain/drift diagnosis region determination unit 111 checks whether or not air-fuel ratio control feedback is being performed. In the case in which the air-fuel ratio control feedback is being performed (YES in S9), the process proceeds to the process of Step S10. In the case in which the air-fuel ratio control feedback is not being performed (NO in S9), the process proceeds to the process of Step S13.

Subsequently, in Step S10, the gain/drift diagnosis region determination unit 111 checks whether or not a used sensor has failed. In the case in which the sensor is normal (YES in S10), the process proceeds to the process of Step S11. In the case in which the sensor has failed (NO in S10), the process proceeds to the process of Step S13. Sensors to be determined are various sensors including the humidity sensor 102 provided in a target system (internal combustion engine system 250).

Subsequently, in Step S11, the gain/drift diagnosis region determination unit 111 checks whether the heater 105 is turned on, proceeds to the process of Step S12 in the case in which the heater 105 is turned on (YES in S11), and proceeds to the process of Step S13 in the case in which the heater 105 is turned off (NO in S11).

Subsequently, in Step S12, in the case in which all of the conditions of Steps S1 to S11 are satisfied, the gain/drift diagnosis region determination unit 111 determines that a state of the internal combustion engine system 250 is within the gain/drift diagnosis region.

On the other hand, in Step S13, in the case in which none of the conditions in Steps S1 to S11 is satisfied, the gain/drift diagnosis region determination unit 111 determines that the state of the internal combustion engine system 250 is not within the gain/drift diagnosis region. After the process of Step S12 or S13, the process returns to the process of Step S1.

The processes in Step S8 (during fuel cut) and Step S9 (during air-fuel ratio feedback) described above may be omitted. The same determination processing step in the flowcharts of FIGS. 21 and 24 which will be described later can be similarly omitted.

[Output Process of C-V Conversion Circuit]

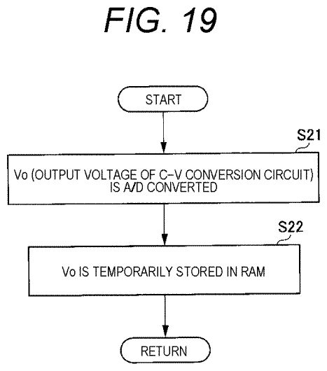

FIG. 19 is a flowchart for describing an output process example of the C-V conversion circuit 103 of the humidity sensor diagnosis device 130. In the embodiment, in the case in which it is determined in FIG. 18 that the state of the internal combustion engine system 250 is within the gain/drift diagnosis region, the output voltage Vo of the C-V conversion circuit 103 is measured.

In Step S21, the output voltage Vo of the C-V conversion circuit 103 is analog-digital converted by the A/D conversion circuit 223. Also, in Step S22, the output voltage Vo converted into digital data is stored in the RAM 228 according to an instruction from the MPU 225 or directly. Here, the output voltage Vo is stored in the RAM 228 every 10 ms. Although an example of operating in a 10 ms task is shown in the embodiment, the present invention is not limited thereto.

[Gain/Drift Deterioration Detection Processing]

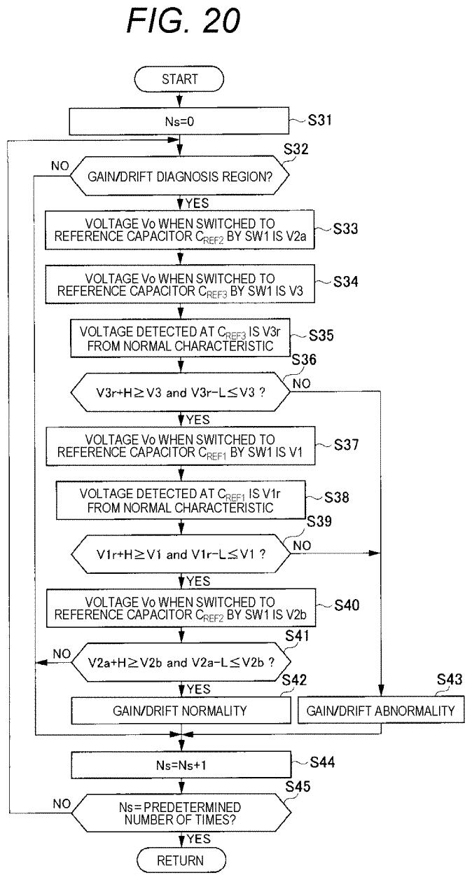

FIG. 20 is a flowchart for describing an exemplary procedure of a gain/drift deterioration detection processing using the gain/drift reference characteristic comparison unit 112 and the gain/drift determination unit 114.

First, in Step S31, the gain/drift reference characteristic comparison unit 112 initializes (sets to 0) the number of times (the number of times of diagnosis sequence) Ns of performing the diagnosis sequence of FIG. 11. Subsequently, in Step S32, the gain/drift reference characteristic comparison unit 112 receives the determination result of the gain/drift diagnosis region determination unit 111, and checks whether the state of the internal combustion engine system 250 is within the gain/drift diagnosis region. In the case in which the state of the internal combustion engine system 250 is within the gain/drift diagnosis region (YES in S32), the process proceeds to the process of Step S33, and in the case in which the state of the internal combustion engine system 250 is not within the gain/drift diagnosis region (NO in S32), the process proceeds to the process of Step S44.

Subsequently, in Step S33, the gain/drift reference characteristic comparison unit 112 switches the reference capacitor of the C-V conversion circuit 103 (FIG. 10) to the reference capacitor C_{REF2} by the switch SW1. In addition, the gain/drift reference characteristic comparison unit 112 sets the output voltage Vo of the C-V conversion circuit 103 detected at this time to V2a. As described above, the reference capacitor switching determination unit 113 determines the switching of the reference capacitor.

Subsequently, in Step S34, the gain/drift reference characteristic comparison unit 112 switches the reference capacitor of the C-V conversion circuit 103 to the reference capacitor C_{REF3} by the switch SW1 and sets the output voltage Vo detected at this time to V3. Subsequently, in Step S35, the gain/drift reference characteristic comparison unit 112 sets the output voltage Vo obtained from the normal reference characteristic 1210 (FIG. 12, FIG. 13) as V3r.

Subsequently, in Step S36, the gain/drift reference characteristic comparison unit 112 determines whether the condition (V3r+H≥V3 and V3r−L≤V3) is satisfied, and if the condition is satisfied (YES in S36), it is determined that the output voltage Vo is within the margin of the normal reference characteristic 1210 and the process proceeds to the process of Step S37. On the other hand, in the case in which the condition in Step S36 is not satisfied (NO in S36), the gain/drift determination unit 114 determines in Step S43 that the gain or the drift of the humidity sensor 102 is abnormal.

Subsequently, if the process proceeds to the process of Step S37, the gain/drift reference characteristic comparison unit 112 switches the reference capacitor of the C-V conversion circuit 103 to the reference capacitor C_{REF1} by the switch SW1 and sets the output voltage Vo detected at this time to V1. Subsequently, in Step S38, the gain/drift reference characteristic comparison unit 112 sets the output voltage Vo obtained from the normal reference characteristic 1210 (FIG. 12, FIG. 13) to V1r.

Subsequently, in Step S39, the gain/drift reference characteristic comparison unit 112 determines whether the condition (V1r+H≥V1 and V1r−L≤V1) is satisfied, and if the condition is satisfied (YES in S39), it is determined that the output voltage Vo is within the margin of the normal reference characteristic 1210 and the process proceeds to the process of Step S40. On the other hand, in the case in which the condition in Step S39 is not satisfied (NO in S39), the gain/drift determination unit 114 determines in Step S43 that the gain or the drift of the humidity sensor 102 is abnormal.

Subsequently, if the process proceeds to the process of Step S40, the gain/drift reference characteristic comparison unit 112 switches the reference capacitor of the C-V conversion circuit 103 to the reference capacitor C_{REF2} by the switch SW1 and sets the output voltage Vo detected at this time to V2b.

Subsequently, in Step S41, the gain/drift reference characteristic comparison unit 112 determines whether the conditions (V2a+H≥V2b and V2a−L≤V2b) are satisfied, and if the conditions are satisfied (YES in S41), the gain/drift determination unit 114 determines that the gain or the drift of the humidity sensor 102 is normal in Step S42. The determination processing in Step S41 is a condition for checking that the humidity is in a constant state during diagnosis.

On the other hand, in the case in which the condition in Step S41 is not satisfied (NO in S41), the process proceeds to the process of Step S44. Furthermore, in Step S44, the number of times Ns of the diagnosis sequence is incremented (Ns=Ns+1). In addition, after the gain/drift normality determination in Step S42 and after the gain/drift abnormality determination in Step S43, the process proceeds to the process of Step S44.

Subsequently, in Step S45, in the case in which the number of times Ns of the diagnosis sequence has reached the predetermined number of times (YES in S45), the diagnosis is completed, and in the case in which the number of times Ns of the diagnosis sequence has not reached the predetermined number of times (NO in S45), the processing proceeds to the diagnosis region determination processing of gain/drift in Step S32 again. Note that, the upper limit margin H and the lower limit margin L shown in this flowchart may be constants or may be a table defined in association with the intake air temperature.

[Response Deterioration Diagnosis Region Determination Processing when Heater is Turned On]

FIG. 21 is a flowchart for describing a procedure example of response deterioration diagnosis region determination processing when the heater is turned on using the heater ON response deterioration diagnosis region determination unit 115. Each step of FIG. 21 is a diagnosis region determination condition in the response deterioration diagnosis when the heater is turned on.

Since the processes of Steps S51 to S61 illustrated in FIG. 21 are the same as the processes of Steps S1 to S11 of FIG. 18, detailed description thereof will be omitted. In each of Steps S51 to S61, in the case in which the determination condition is not satisfied, the process proceeds to the process of Step S64.

After the determination process in Step S61, in Step S62, the heater ON response deterioration diagnosis region determination unit 115 checks whether the diagnosis result of the gain/drift deterioration diagnosis of FIG. 20 is normal. Moreover, the heater ON response deterioration diagnosis region determination unit 115 proceeds to the process of Step S63 in the case in which the diagnosis result of the gain/drift deterioration diagnosis is normal (YES in S62) and proceeds to the process of Step S64 in the case in which the diagnosis result of the gain/drift deterioration diagnosis is abnormal (NO in S62).

Subsequently, in Step S63, in the case in which all of the conditions in Steps S51 to S62 are satisfied, the heater ON response deterioration diagnosis region determination unit 115 determines that the state of the internal combustion engine system 250 is within the response deterioration diagnosis region when the heater is turned on.

On the other hand, in Step S64, in the case in which none of the conditions in Steps S51 to S62 is satisfied, the heater ON response deterioration diagnosis region determination unit 115 determines that the state of the internal combustion engine system 250 is not within the response deterioration diagnosis region when the heater is turned on. After the process of Step S63 or S64, the processing of this flowchart is repeatedly performed.

[Falling Response Deterioration Detection Processing when Heater is Turned On]

FIG. 22 is a flowchart for describing a procedure example of falling response deterioration detection processing when the heater is turned on by the heater ON response deterioration diagnosis time constant detection unit 116 and the heater ON response deterioration determination unit 117.

First, in Step S71, the heater ON response deterioration diagnosis time constant detection unit 116 initializes (sets to 0) the falling response deterioration index Id and the number of times (the number of times of diagnosis sequence) Nd that the diagnosis sequence of FIG. 11 has been performed.

Subsequently, in Step S72, the heater ON response deterioration diagnosis time constant detection unit 116 acquires the determination result of the heater ON response deterioration diagnosis region determination unit 115 and checks whether the state of the internal combustion engine system 250 is within the heater ON response deterioration diagnosis region. In the case in which the state of the internal combustion engine system 250 is within the heater ON response deterioration diagnosis region (YES in S72), the process proceeds to the process of Step S73, and in the case in which the state of the internal combustion engine system 250 is not within the heater ON response deterioration diagnosis region (NO in S72), the process proceeds to the process of Step S82.

Subsequently, in Step S73, the heater ON response deterioration diagnosis time constant detection unit 116 determines whether the switch SWC of the C-V conversion circuit 103 is turned on, the switch SWT is turned off, and the switch SWR is turned on. In the case in which the switches SWC, SWT, and SWR satisfy this condition (YES in S73), the process proceeds to the process of Step S74, and in the case in which the conditions are not satisfied (NO in S73), the process proceeds to the process of Step S82.

In the case of NO in Step S72 or NO in Step S73, in Step S82, the heater ON response deterioration diagnosis time constant detection unit 116 initializes the falling response deterioration index Id and the number of times of diagnosis sequence Nd.

Subsequently, in the case of YES in step S73, in Step S74, the heater ON response deterioration diagnosis time constant detection unit 116 differentiates the signal (time-series data) of the output voltage Vo. That is to say, the heater ON response deterioration diagnosis time constant detection unit 116 calculates a difference value ΔVo between the output voltage Vo measured in the previous diagnosis sequence and the output voltage Vo measured in the current diagnosis sequence.

Subsequently, in Step S75, the heater ON response deterioration diagnosis time constant detection unit 116 calculates the square of the difference value ΔVo. Subsequently, in Step S76, the heater ON response deterioration diagnosis time constant detection unit 116 adds (integrates) the square value of the difference value ΔVo to the falling response deterioration index Id.

Subsequently, in Step S77, the heater ON response deterioration diagnosis time constant detection unit 116 increments the number of times of diagnosis sequence Nd (Nd=Nd+1). Here, in Step S78, the heater ON response deterioration diagnosis time constant detection unit 116 determines whether the number of times of diagnosis sequence Nd has reached a first predetermined number of times. In the case in which the number of times of diagnosis sequence Nd has reached the first predetermined number of times, the process proceeds to the process of Step S79, and in the case in which the number of times of diagnosis sequence Nd has not reached the first predetermined number of times, the process proceeds to the process of Step S73.

Subsequently, in Step S79, the heater ON response deterioration diagnosis time constant detection unit 116 compares the falling response deterioration index Id with a preset first threshold value. In the case in which the falling response deterioration index Id is equal to or more than the first threshold value (YES in S79), the process proceeds to the process of Step S80, and in the case in which the falling response deterioration index Id is less than the first threshold value (NO in S79), the process proceeds to the process of Step S81.

Subsequently, in the case of YES in Step S79, the heater ON response deterioration determination unit 117 determines in Step S80 that the fall response when the heater is turned on is normal. Also, in the case of NO in Step S79, the heater ON response deterioration determination unit 117 determines in Step S81 that the fall response when the heater is turned on is abnormal. After the process in any one of Steps S80 to S82 ends, the processing of this flowchart is repeatedly performed.

Note that the falling response deterioration index Id indicates a reciprocal of a time constant of the output voltage Vo. Furthermore, the first threshold value may be a table defined in association with the intake air temperature.

[Rising Response Deterioration Detection Processing when Heater is Turned On]

FIG. 23 is a flowchart for describing a procedure example of rising response deterioration detection processing when the heater is turned on using the heater ON response deterioration diagnosis time constant detection unit 116 and the heater ON response deterioration determination unit 117. This flowchart is obtained by replacing the falling response deterioration index Id of FIG. 22 with “rising response deterioration index Iu” and the number of times of diagnosis sequence Nu with “number of times of diagnosis sequence Nu” and has processing steps similar to those of FIG. 22.

First, in Step S91, the heater ON response deterioration diagnosis time constant detection unit 116 initializes (sets to 0) the rising response deterioration index Iu and the number of times (the number of times of diagnosis sequence) Nu of performing the diagnosis sequence of FIG. 11.

Subsequently, in Step S92, the heater ON response deterioration diagnosis time constant detection unit 116 acquires the determination result of the heater ON response deterioration diagnosis region determination unit 115 and checks whether the state of the internal combustion engine system 250 is within the heater ON response deterioration diagnosis region. In the case in which the state of the internal combustion engine system 250 is within the heater ON response deterioration diagnosis region (YES in S92), the process proceeds to the process of Step S93, and in the case in which the state of the internal combustion engine system 250 is not within the heater ON response deterioration diagnosis region (NO in S92), the process proceeds to the process of Step S102.

Subsequently, in Step S93, the heater ON response deterioration diagnosis time constant detection unit 116 determines whether the switch SWC of the C-V conversion circuit 103 is turned off, the switch SWT is turned on, and the switch SWR is turned off. In the case in which the switches SWC, SWT, and SWR satisfy this condition (YES in S93), the process proceeds to the process of Step S94, and in the case in which the conditions are not satisfied (NO in S93), the process proceeds to the process of Step S102.

In the case of NO in Step S92 or NO in Step S93, in Step S102, the heater ON response deterioration diagnosis time constant detection unit 116 initializes the rising response deterioration index Iu and the number of times of diagnosis sequence Nu.

Subsequently, in the case of YES in Step S93, the heater ON response deterioration diagnosis time constant detection unit 116 differentiates the output voltage Vo in Step S94. That is to say, the heater ON response deterioration diagnosis time constant detection unit 116 calculates a difference value ΔVo between the output voltage Vo measured in the previous diagnosis sequence and the output voltage Vo measured in the current diagnosis sequence.

Subsequently, in Step S95, the heater ON response deterioration diagnosis time constant detection unit 116 calculates the square of the difference value ΔVo. Subsequently, in Step S96, the heater ON response deterioration diagnosis time constant detection unit 116 adds (integrates) the square value of the difference value ΔVo to the rising response deterioration index Iu.

Subsequently, in Step S97, the heater ON response deterioration diagnosis time constant detection unit 116 increments the number of times of diagnosis sequence Nu (Nu=Nu+1). Here, in Step S98, the heater ON response deterioration diagnosis time constant detection unit 116 determines whether the number of times of diagnosis sequence Nu has reached a second predetermined number of times. Furthermore, in the case in which the number of times of diagnosis sequence Nu has reached the second predetermined number of times, the process proceeds to the process of Step S99, and in the case in which the number of times of diagnosis sequence Nu has not reached the second predetermined number of times, the process proceeds to the process of Step S93.

Subsequently, in Step S99, the heater ON response deterioration diagnosis time constant detection unit 116 compares the rising response deterioration index Iu with a preset second threshold value. In addition, in the case in which the rising response deterioration index Iu is greater than or equal to the second threshold value (YES in S99), the process proceeds to the process of Step S100, and in the case in which the rising response deterioration index Iu is less than the second threshold value (NO in S99), the process proceeds to the process of Step S101.

Subsequently, in the case of YES in Step S99, the heater ON response deterioration determination unit 117 determines in Step S100 that the rise response when the heater is turned on is normal. In addition, in the case of NO in Step S99, the heater ON response deterioration determination unit 117 determines in Step S101 that the rise response when the heater is turned on is abnormal. After the process in any one of Steps S100 to S102 ends, the processing of this flowchart is repeatedly performed.

Note that, as in the case of the rising response deterioration detection described above, the rising response deterioration index Iu indicates the reciprocal of the time constant of the output voltage Vo. The second threshold value may include a table defined in association with the intake air temperature.

[Response Deterioration Diagnosis Region Determination Processing when Heater is Turned Off]

FIG. 24 is a flowchart for describing a procedure example of response deterioration diagnosis region determination processing when the heater is turned off using the heater OFF response deterioration diagnosis region determination unit 118. Each step of FIG. 24 is a diagnosis region determination condition in the response deterioration diagnosis when the heater is turned off.

Since the processes of Steps S111 to S120 illustrated in FIG. 24 are the same as the processes of Steps S51 to S60 of FIG. 21, detailed description thereof will be omitted. In each of Steps S51 to S60, in the case in which the determination condition is not satisfied, the process proceeds to the process of Step S124.

After the determination process of Step S120, in Step S121, the heater OFF response deterioration diagnosis region determination unit 118 checks whether the heater 105 is turned off. In the case in which the heater 105 is turned off (YES in S121), the process proceeds to the process of Step S122, and in the case in which the heater 105 is turned on (NO in S121), the process proceeds to the process of Step S124.

Subsequently, in Step S122, the heater OFF response deterioration diagnosis region determination unit 118 checks whether the diagnosis result of the gain/drift deterioration diagnosis of FIG. 20 is normal. Moreover, in the case in which the diagnosis result of the gain/drift deterioration diagnosis is normal (YES in S122), the heater OFF response deterioration diagnosis region determination unit 118 proceeds to the process of Step S123, and in the case in which the diagnosis result of the gain/drift deterioration diagnosis is abnormal (NO in S122), the heater OFF response deterioration diagnosis region determination unit proceeds to the process of Step S124.

Subsequently, in Step S123, in the case in which all of the conditions in Steps S111 to S122 are satisfied, the heater OFF response deterioration diagnosis region determination unit 118 determines that the state of the internal combustion engine system 250 is within the response deterioration diagnosis region when the heater is turned off.

On the other hand, in Step S124, in the case in which any one of the conditions in Steps S111 to S122 is not satisfied, the heater OFF response deterioration diagnosis region determination unit 118 determines that the state of the internal combustion engine system 250 is not within the response deterioration diagnosis region when the heater is turned off. After the process of Step S123 or S124, the processing of this flowchart is repeatedly performed.

[Rising Response Deterioration Detection Processing when Heater is Turned Off]

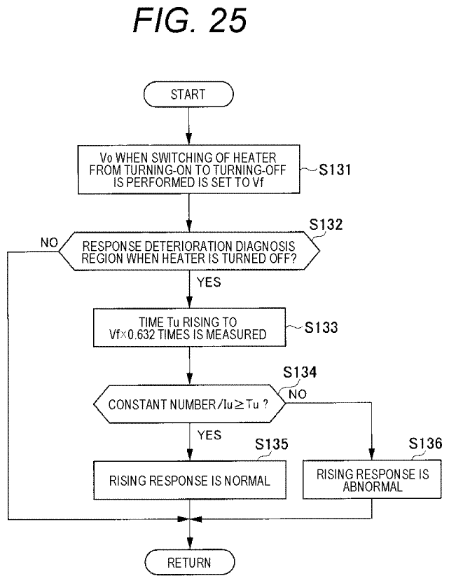

FIG. 25 is a flowchart for describing a procedure example of rising response deterioration detection processing when the heater is turned off using the heater OFF response deterioration diagnosis time constant detection unit 119 and the heater OFF response deterioration determination unit 120.

First, in Step S131, the heater OFF response deterioration diagnosis time constant detection unit 119 sets the output voltage Vo of the C-V conversion circuit 103 when the heater is turned off (when the heater is switched from being turned-on to being turned-off) to the final value Vf (FIG. 17).

Subsequently, in Step S132, the heater OFF response deterioration diagnosis time constant detection unit 119 acquires the determination result of the heater OFF response deterioration diagnosis region determination unit 118 and checks whether the state of the internal combustion engine system 250 is within the heater OFF response deterioration diagnosis region. In the case in which the state of the internal combustion engine system 250 is within the heater OFF response deterioration diagnosis region (YES in S132), the process proceeds to the process of Step S133, and in the case in which the state of the internal combustion engine system 250 is not within the heater OFF response deterioration diagnosis region (NO in S132), the detection processing ends.

Subsequently, in Step S133, the heater OFF response deterioration diagnosis time constant detection unit 119 measures a time Tu for increasing to the final value Vf×0.632 times. In the example of FIG. 17, the time Tu corresponds to the time constant τ1 or τ2.

Subsequently, in Step S134, the heater OFF response deterioration diagnosis time constant detection unit 119 compares (constant/Iu) (FIG. 23) with Tu. In the case in which (constant/Iu) is equal to or more than Tu (YES in S134), the process proceeds to the process of Step S135. In the case in which (constant/Iu) is less than Tu (NO in S134), the process proceeds to the process of Step S136.

Subsequently, in the case of YES in Step S134, the heater OFF response deterioration determination unit 120 determines in Step S135 that the rise response when the heater is turned off is normal. Also, in the case of NO in Step S134, in Step S136, the heater OFF response deterioration determination unit 120 determines that the rise response when the heater is turned off is abnormal. In the case of NO in Step S132, the processing of this flowchart is repeatedly performed after the process of Step S135 or S136 is completed.

Since the rising response deterioration index Iu is a reciprocal of the time constant, (constant/Iu) is converted into the time constant by taking the reciprocal and can be compared with the time Tu.

According to the above-described embodiment, a more accurate functional diagnosis (gain deterioration, drift (offset) deterioration, and response deterioration) can be performed on the humidity sensor 102 and the state thereof is maintained.

As described above, the humidity sensor diagnosis device (humidity sensor diagnosis device 130) according to the embodiment is a humidity sensor diagnosis device which diagnoses a humidity sensor (humidity sensor 102) configured to detect humidity of intake air using a change in capacitance provided in an intake air system of an internal combustion engine, the humidity sensor diagnosis device including: a capacitance-voltage conversion circuit (CV conversion circuit 103) which includes a plurality of reference capacitors (C_{REF1} to C_{REF3}) having different pieces of capacitance and a switch (switch SW1) which switches the reference capacitors and outputs a voltage in accordance with the capacitance of the humidity sensor; and a diagnosis unit (diagnosis unit 110) which compares an output voltage (Vo) of the capacitance-voltage conversion circuit with a reference voltage obtained from a reference characteristic (normal reference characteristic 1210) of the humidity sensor and diagnoses the humidity sensor based on a comparison result. The diagnosis unit changes the output voltage by changing the capacitance of the capacitance-voltage conversion circuit by a switch in a state in which the output voltage of the capacitance-voltage conversion circuit is within a certain range and compares the changed output voltage with a reference voltage.

In the first embodiment configured as described above, a plurality of reference capacitors having different pieces of capacitance are provided in the capacitance-voltage conversion circuit. Furthermore, when the output voltage of the capacitance-voltage conversion circuit maintains a state within a certain range, the output voltage is changed by changing the capacitance of the capacitance-voltage conversion circuit and the humidity sensor is diagnosed by comparing the changed output voltage with a reference voltage obtained from the reference characteristic. According to the first embodiment, since the humidity sensor element itself does not have a diagnostic function (diagnostic reference capacitor) and the reference capacitors of the capacitance-voltage conversion circuit are switched, the plurality of reference capacitors are not exposed to the inflow gas and the plurality of reference capacitors are less likely to deteriorate. For this reason, the detection accuracy of the diagnostic function of the humidity sensor diagnosis device is less likely to deteriorate. More accurate functional diagnosis can be performed on the humidity sensor and the state is maintained.

In addition, in the embodiment, since the number of switches is smaller than that in the technique described in PTL 1, the possibility of erroneous diagnosis due to a switch failure is reduced.

Furthermore, in the first embodiment described above, a heater (heater 105) which heats the humidity sensor is provided and the temperature of the humidity sensor is kept constant using the heater. As a result, since the diagnosis can be performed while the temperature of the humidity sensor at the time of diagnosis is maintained constant, accurate diagnosis can be performed.

Moreover, in the first embodiment described above, the diagnosis unit (diagnosis unit 110) is configured to compare the output voltage (Vo) of the capacitance-voltage conversion circuit (C-V conversion circuit 103) with a reference voltage obtained from a reference characteristic (normal reference characteristic 1210) of the humidity sensor (humidity sensor 102), determine that the humidity sensor is normal in the case in which a difference between the output voltage and the reference voltage is within a predetermined value (upper limit margin H, lower limit margin L), and determine that the humidity sensor has an abnormality due to gain deterioration or drift deterioration in the case in which the difference between the output voltage and the reference voltage exceeds a predetermined value.

According to the embodiment having the above configuration, the gain deterioration or the drift deterioration of the humidity sensor can be more accurately performed and the state is maintained.

In addition, in the first embodiment described above, the diagnosis unit (diagnosis unit 110) is configured to be able to shift to the response deterioration diagnosis of the humidity sensor in the case in which the gain deterioration or the drift deterioration of the humidity sensor (humidity sensor 102) is not detected.

According to the embodiment having the above configuration, in the case in which the characteristics (gain, slide (offset)) of the humidity sensor are normal, the response deterioration diagnosis can be performed and both of the characteristic diagnosis and the response diagnosis can be performed. In addition, since the response deterioration diagnosis is performed in the case in which the gain and the drift are normal, it is possible to perform more accurate response deterioration diagnosis on the humidity sensor.

Furthermore, in the first embodiment described above, the diagnosis unit (diagnosis unit 110) is configured to calculate a time constant of a fall of the output voltage at the time of charging and a time constant of a rise of the output voltage at the time of discharging with respect to the capacitance-voltage conversion circuit (C-V conversion circuit 103) in the response deterioration diagnosis of the humidity sensor (humidity sensor 102) when the heater is turned on. With such a configuration, it is possible to diagnose the response deterioration of the fall and the rise of the output voltage when the heater is turned on.

In addition, in the first embodiment described above, the diagnosis unit (diagnosis unit 110) is configured to calculate the reciprocal (response deterioration index Id) of the falling time constant of the output voltage by differentiating the signal of the output voltage (Vo) at the time of charging, then squaring the differentiated value, and then integrating the squared value. Furthermore, the diagnosis unit (diagnosis unit 110) is configured to determine that the response characteristic of the falling of the output voltage is normal in the case in which the reciprocal of the falling time constant of the output voltage (Vo) is equal to or greater than the threshold value (Th2) and determine that the response characteristic of the falling of the output voltage is abnormal in the case in which the reciprocal of the falling time constant of the output voltage (Vo) is less than the threshold value.

With such a configuration, the diagnosis unit can diagnose the falling response deterioration using the reciprocal of the falling time constant of the output voltage as the falling response deterioration index and comparing it with the threshold value (Th2).

In addition, in the first embodiment described above, the diagnosis unit (diagnosis unit 110) is configured to calculate the reciprocal (response deterioration index Iu) of the rising time constant of the output voltage by differentiating, squaring, and then integrating the signal of the output voltage (Vo) at the time of discharging. Furthermore, the diagnosis unit (diagnosis unit 110) is configured to determine that the response characteristic of the rise of the output voltage is normal in the case in which the reciprocal of the rising time constant of the output voltage (Vo) is equal to or greater than the threshold value (Th1) and determine that the response characteristic of the rise of the output voltage is abnormal in the case in which the reciprocal of the rising time constant of the output voltage (Vo) is less than the threshold value.

With such a configuration, the diagnosis unit can use the reciprocal of the rising time constant of the output voltage as a rising response deterioration index and compare the rising response deterioration index with the threshold value (Th1) to diagnose the rising response deterioration.

Furthermore, in the first embodiment described above, in the response deterioration diagnosis of the humidity sensor (humidity sensor 102) when the heater (heater 105) is switched from being turned-on to being turned-off, the diagnosis unit (diagnosis unit 110) is configured to calculate a rising time constant (Tu) of the output voltage when the heater is turned off for the capacitance-voltage conversion circuit (C-V conversion circuit 103), further take a reciprocal of a reciprocal of (constant/Iu) of the rising time constant of the output voltage when the heater is turned on at the time of discharging to make the time constant and compare the rising time constant of the output voltage when the heater is turned off with a value obtained by making the time constant based on the rising time constant of the output voltage when the heater is turned on. Furthermore, the diagnosis unit determines that the response characteristic of the output voltage when the heater is turned off is normal in the case in which the rising time constant of the output voltage when the heater is turned off is equal to or less than the value obtained by the time constant conversion and determines that the response characteristic of the output voltage when the heater is turned off is abnormal in the case in which the rising time constant of the output voltage when the heater is turned off exceeds the value obtained by the time constant conversion.

According to the embodiment with the above configuration, it is possible to diagnose the falling of the output voltage and the response deterioration of the rising thereof when the heater is turned off.

In addition, in the first embodiment described above, the diagnosis unit (diagnosis unit 110) includes a gain/drift diagnosis region determination unit (gain/drift diagnosis region determination unit 111) which determines whether the state of the internal combustion engine (internal combustion engine 240) corresponds to a gain/drift diagnosis region in which detection processing of gain deterioration or drift deterioration of the humidity sensor (humidity sensor 102) can be performed. Also, in the case in which the gain/drift diagnosis region determination unit determines that the state of the internal combustion engine corresponds to the gain/drift diagnosis region, the diagnosis unit is configured to be able to shift to a process of detecting gain deterioration or drift deterioration of the humidity sensor.

According to the embodiment with the above configuration, in the case in which the state of the internal combustion engine corresponds to the gain/drift diagnosis region, the process shifts to the process of detecting the gain deterioration or the drift deterioration of the humidity sensor. Thus, it is possible to detect gain deterioration or drift deterioration more accurately.

In addition, in the first embodiment described above, the diagnosis unit (diagnosis unit 110) includes a first response deterioration diagnosis region determination unit (heater ON response deterioration diagnosis region determination unit) which determines whether the state of the internal combustion engine (internal combustion engine 240) corresponds to a first response deterioration diagnosis region in which the response deterioration detection processing when the heater of the humidity sensor (humidity sensor 102) is turned on can be performed. Furthermore, the first response deterioration diagnosis region determination unit is configured to determine that the state of the internal combustion engine does not correspond to the first response deterioration diagnosis region at least in the case in which the heater (heater 105) is turned off or in the case in which gain deterioration or drift deterioration is detected and the diagnosis unit does not shift to the response deterioration detection processing when the heater is turned on in response to the determination result of the first response deterioration diagnosis region determination unit.

According to the embodiment with the above configuration, at least in the case in which the heater is turned off or in the case in which gain deterioration or drift deterioration is detected, the response deterioration detection processing does not proceed to the response deterioration detection processing when the heater is turned on in response to the determination result of the first response deterioration diagnosis region determination unit. Thus, it is possible to prevent deterioration of the detection accuracy of response deterioration when the heater is turned on.

In the first embodiment described above, the diagnosis unit (diagnosis unit 110) includes a second response deterioration diagnosis region determination unit (heater OFF response deterioration diagnosis region determination unit) which determines whether the state of the internal combustion engine (internal combustion engine 240) corresponds to a second response deterioration diagnosis region in which the response deterioration detection processing of the humidity sensor (humidity sensor 102) when the heater is turned off can be performed. Also, the second response deterioration diagnosis region determination unit is configured to determine that the state of the internal combustion engine does not correspond to the second response deterioration diagnosis region at least in the case in which the heater (heater 105) is turned on or in the case in which gain deterioration or drift deterioration is detected and the diagnosis unit does not shift to the response deterioration detection processing when the heater is turned off in response to the determination result of the second response deterioration diagnosis region determination unit.

According to the embodiment having the above configuration, at least in the case in which the heater is turned on or in the case in which gain deterioration or drift deterioration is detected, the second response deterioration diagnosis region determination unit receives the determination result and does not shift to the response deterioration detection processing when the heater is turned off. Thus, it is possible to prevent deterioration of the detection accuracy of response deterioration when the heater is turned off.

In addition, in the first embodiment described above, the capacitance-voltage conversion circuit (C-V conversion circuit 103) outputs a voltage (Vo) corresponding to humidity based on the capacitance (Cs) which changes in relation to the relative permittivity of moisture in the air and a substance (the moisture-sensitive film 401) having a relative permittivity different from that of water provided in the humidity sensor.

Furthermore, in the first embodiment described above, the diagnosis unit (diagnosis unit 110) switches to the same reference capacitor (for example, C_{REF2}) twice by the switch (switch SW1) and confirms that the difference between the two output voltages (Vo) obtained using the capacitance-voltage conversion circuit (C-V conversion circuit 103) when switching to the reference capacitor is within a certain range. With such a configuration, it is possible to confirm that the environment of the humidity sensor is constant during diagnosis and to perform accurate diagnosis.

### 2. Second Embodiment

A second embodiment has a configuration in which a circuit which amplifies capacitance of a reference capacitor is provided instead of the capacitor parallel circuit 1000 in the C-V conversion circuit 103 (refer to FIG. 10) in the first embodiment.

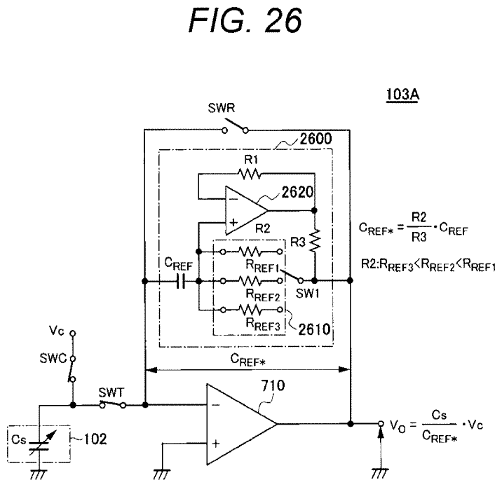

FIG. 26 illustrates an example of a C-V conversion circuit provided in a humidity sensor diagnosis device according to the second embodiment. In a C-V conversion circuit 103A illustrated in FIG. 26, a capacitance amplifier circuit 2600 is connected in parallel between an inverting input terminal and an output terminal of an operational amplifier 710 and the diagnosis of the present invention can be performed even with small capacitance.

The capacitance amplifier circuit 2600 includes a fixed reference capacitor C_{REF}, a resistor-parallel circuit 2610 (resistor R2), a switch SW1, an operational amplifier 2620, a resistor R1, and a resistor R3. A series circuit of the fixed reference capacitor C_{REF}, the resistor-parallel circuit 2610 (resistor R2), and the switch SW1 is connected in parallel between the inverting input terminal and the output terminal of the operational amplifier 710. The resistor-parallel circuit 2610 is a parallel circuit of three reference resistors R_{REF1} to R_{REF3} and one reference resistor R_{REF*} is selected by the switch SW1. In addition, a connection midpoint between the capacitor C_{REF} and the resistor-parallel circuit 2610 is connected to a non-inverting input terminal of the operational amplifier 2620 and an output terminal of the operational amplifier 710 is connected to an output terminal of the operational amplifier 2620 via the resistor R3. Furthermore, the resistor R1 is connected between the inverting input terminal and the output terminal of the operational amplifier 2620. Moreover, the switch SWR is connected between the inverting input terminal and the output terminal of the operational amplifier 710.

In the above configuration, the capacitance of the reference capacitor C_{REF*} in the capacitance amplifier circuit 2600 can be expressed by Expression (7). By switching the reference resistors R_{REF1} to R_{REF3} of the resistor R2, the capacitance of the reference capacitor C_{REF*} can be amplified.

$${C}_{REF *} = \frac{R 2}{R 3} \cdot {C}_{REF} \qquad ( 7 )$$

Generally, if the capacitance of the capacitor increases, the housing of the capacitor also increases. Thus, the area and volume of the circuit increase. As a countermeasure therefor, the capacitance amplifier circuit 2600 can also be used in the sense of maintaining the degree of integration. The diagnosis method itself is the same as that of the first embodiment, and the capacitance of the reference capacitor C_{REF*} is switched by switching the resistor R2 (reference resistors R_{REF1} to R_{REF3}) with the switch SW1 to perform diagnosis. Since the magnitude of the resistance does not change so much even if the resistivity increases, use of this circuit is effective in terms of miniaturization of the circuit. In addition, although a composite material of aluminum oxide (alumina) and glass is often used as a material of resistance, resistance is less likely to deteriorate over time than a capacitor.

The capacitance may be switched by switching the resistor R3 with a switch instead of the resistor R2.

### INDUSTRIAL APPLICABILITY

The humidity sensor diagnosis device 130 can accurately diagnose gain deterioration, drift (offset) deterioration, and response deterioration with respect to the humidity sensor 102 attached to the internal combustion engine system 250 and is a technique suitable for use in strengthening vehicle self-diagnosis regulations.

Furthermore, the present invention is not limited to each of the above-described embodiments, and it goes without saying that various other application examples and modifications can be taken without departing from the gist of the present invention described in the claims.

For example, each of the above-described embodiments describes the configuration of the humidity sensor diagnosis device in detail and specifically in order to help understanding of the present invention and is not necessarily limited to one including all of the constituent elements described above. In addition, it is also possible to add, replace, or delete other components for a part of the configuration of each embodiment.

In addition, some or all of the above-described configurations, functions, processing units, and the like may be realized by hardware, for example, by designing with an integrated circuit. A field programmable gate array (FPGA), an application specific integrated circuit (ASIC), or the like may be used as the hardware. In addition, each of the above-described constituent elements, functions, and the like may be realized by software by a processor (for example, the MPU 225) included in a computer interpreting and executing a program for realizing each function. Information of a program, a table, a file, and the like for realizing each function can be stored in a recording device such as a semiconductor memory (ROM 227), a hard disk, or a solid state drive (SSD), or a recording medium such as an IC card, an SD card, or an optical disk.

Furthermore, in the flowchart described in the first embodiment, a plurality of processes may be executed in parallel or the processing order may be changed within a range not affecting the processing result.

In addition, in the above-described embodiments, control lines and information lines considered to be necessary for description are illustrated and not all control lines and information lines are necessarily illustrated in terms of products. In practice, it may be considered that almost all the components are connected to each other.

### REFERENCE SIGNS LIST

101 humidity detector
102 humidity sensor
103, 103A CV conversion circuit
104 temperature sensor
105 heater
110 diagnosis unit
111 gain/drift diagnosis region determination unit
112 gain/drift reference characteristic comparison unit
113 reference capacitor switching determination unit
114 gain/drift determination unit
115 heater ON response deterioration diagnosis region determination unit (first response deterioration diagnosis region determination unit)
116 heater ON response deterioration diagnosis time constant detection unit
117 heater ON response deterioration determination unit
118 heater OFF response deterioration diagnosis region determination unit (second response deterioration diagnosis region determination unit)
119 heater OFF response deterioration diagnosis time constant detection unit
120 heater OFF response deterioration determination unit
121 normality/abnormality determination unit
122 correction unit for each control using humidity sensor
130 humidity sensor diagnosis device (C-V conversion circuit 103, diagnosis unit 110)
200 air cleaner
201 ignition device
202 fuel injection device
204 flow rate detection device (multi-sensor)
205 air-fuel ratio sensor
206 three-way catalyst
215 oxygen sensor
220 internal combustion engine control device (ECU)
225 MPU
227 ROM
235 warning lamp
240 internal combustion engine
250 internal combustion engine system
310 air flow sensor
320 intake air temperature sensor
401 moisture sensitive film
710 operational amplifier
910 normal reference characteristic
911, 912, 921, 922 characteristics
930, 931 response characteristics
1000 capacitor parallel circuit
1210 normal reference characteristic
1211 upper margin
1212 lower margin
2600 capacitance amplifier circuit
2610 resistor-parallel circuit
2620 operational amplifier
C_{S} equivalent capacitor
C_{REF} fixed reference capacitor
C_{REF*}, C_{REF1} to C_{REF3} reference capacitor
R2, R3 resistance
R_{REF1} to R_{REF3} reference resistor
SW1 switch
Th1, Th2 threshold value
Vₒ output voltage
τ, τ1, τ2 time constant

1. A humidity sensor diagnosis device which diagnoses a humidity sensor configured to detect humidity of intake air based on a change in capacitance provided in an intake air system of an internal combustion engine, the humidity sensor diagnosis device comprising:
a capacitance-voltage conversion circuit including a plurality of reference capacitors having different pieces of capacitance and a switch which switches the reference capacitor, the capacitance-voltage conversion circuit outputting a voltage in accordance with the capacitance of the humidity sensor; and
a diagnosis unit which compares an output voltage of the capacitance-voltage conversion circuit with a reference voltage obtained from a reference characteristic of the humidity sensor and diagnoses the humidity sensor based on a comparison result,
wherein the diagnosis unit changes the output voltage by changing the capacitance of the capacitance-voltage conversion circuit by the switch in a state in which the output voltage of the capacitance-voltage conversion circuit is within a certain range and compares the changed output voltage with the reference voltage.

2. The humidity sensor diagnosis device according to claim 1, wherein a temperature of the humidity sensor is kept constant using a heater.

3. The humidity sensor diagnosis device according to claim 2, wherein
the diagnosis unit compares an output voltage of the capacitance-voltage conversion circuit with the reference voltage obtained from a reference characteristic of the humidity sensor, determines that the humidity sensor is normal in the case in which a difference between the output voltage and the reference voltage is within a predetermined value, and determines that the humidity sensor is abnormal due to gain deterioration or drift deterioration in the case in which the difference between the output voltage and the reference voltage exceeds the predetermined value.

4. The humidity sensor diagnosis device according to claim 3, wherein
the diagnosis unit is capable of shifting to a response deterioration diagnosis of the humidity sensor in the case in which gain deterioration or drift deterioration of the humidity sensor is not detected.

5. The humidity sensor diagnosis device according to claim 4, wherein
the diagnosis unit calculates a time constant of a fall of the output voltage at the time of charging and a time constant of a rise of the output voltage at the time of discharging with respect to the capacitance-voltage conversion circuit in the response deterioration diagnosis of the humidity sensor when the heater is turned on.

6. The humidity sensor diagnosis device according to claim 5, wherein
the diagnosis unit calculates a reciprocal of a falling time constant of the output voltage by differentiating a signal of the output voltage, squaring a differentiated value, and then integrating the squared value at the time of charging.

7. The humidity sensor diagnosis device according to claim 5, wherein
the diagnosis unit calculates a reciprocal of a rising time constant of the output voltage by differentiating, squaring, and then integrating a signal of the output voltage at the time of discharging.

8. The humidity sensor diagnosis device according to claim 6, wherein
the diagnosis unit determines that a response characteristic of a fall of the output voltage is normal in the case in which a reciprocal of a falling time constant of the output voltage is equal to or greater than a threshold value and determines that a response characteristic of a fall of the output voltage is abnormal in the case in which the reciprocal of the falling time constant of the output voltage is less than the threshold value.

9. The humidity sensor diagnosis device according to claim 7, wherein
the diagnosis unit determines that the response characteristic of the rise of the output voltage is normal in the case in which a reciprocal of the rising time constant of the output voltage is equal to or greater than a threshold value and determines that the response characteristic of the rise of the output voltage is abnormal in the case in which the reciprocal of the rising time constant of the output voltage is less than the threshold value.

10. The humidity sensor diagnosis device according to claim 4, wherein
the diagnosis unit performs, in a response deterioration diagnosis of the humidity sensor when the heater is switched from being turned-on to being turned-off,
calculates, for the capacitance-voltage conversion circuit, a rising time constant of the output voltage when the heater is turned off, and obtains a time constant by further taking a reciprocal of a reciprocal of a rising time constant of the output voltage when the heater is turned on and discharging,
compares a rising time constant of the output voltage when the heater is turned off with a value obtained by converting the rising time constant of the output voltage when the heater is turned on into a time constant; and
determines that the response characteristic of the output voltage when the heater is turned off is normal in the case in which a rising time constant of the output voltage when the heater is turned off is equal to or less than a value obtained by converting the rising time constant of the output voltage to the time constant, and determines that the response characteristic of the output voltage when the heater is turned off is abnormal in the case in which the rising time constant of the output voltage when the heater is turned off exceeds the value obtained by converting the rising time constant of the output voltage to the time constant.

11. The humidity sensor diagnosis device according to claim 3, wherein
the diagnosis unit includes a gain/drift diagnosis region determination unit which determines whether a state of the internal combustion engine corresponds to a gain/drift diagnosis region in which detection processing of gain deterioration or drift deterioration of the humidity sensor is able to be performed, and
the diagnosis unit is able to shift to a process of detecting gain deterioration or drift deterioration of the humidity sensor in the case in which the gain/drift diagnosis region determination unit determines that the state of the internal combustion engine corresponds to the gain/drift diagnosis region.

12. The humidity sensor diagnosis device according to claim 4, wherein
the diagnosis unit includes a first response deterioration diagnosis region determination unit which determines whether a state of the internal combustion engine corresponds to a first response deterioration diagnosis region in which a response deterioration detection processing of the humidity sensor when the heater is turned on is able to be performed, and
at least in the case in which the heater is turned off or in the case in which the gain deterioration or the drift deterioration is detected, the first response deterioration diagnosis region determination unit determines that the state of the internal combustion engine does not correspond to the first response deterioration diagnosis region and the diagnosis unit receives a determination result of the first response deterioration diagnosis region determination unit and does not shift to the response deterioration detection processing when the heater is turned on.

13. The humidity sensor diagnosis device according to claim 4, wherein
the diagnosis unit includes a second response deterioration diagnosis region determination unit which determines whether the state of the internal combustion engine corresponds to a second response deterioration diagnosis region in which a response deterioration detection processing of the humidity sensor when the heater is turned off is able to be performed, and
at least in the case in which the heater is turned on or in the case in which the gain deterioration or the drift deterioration is detected, the second response deterioration diagnosis region determination unit determines that the state of the internal combustion engine does not correspond to the second response deterioration diagnosis region and the diagnosis unit receives a determination result of the second response deterioration diagnosis region determination unit and does not shift to the response deterioration detection processing when the heater is turned off.

14. The humidity sensor diagnosis device according to claim 1, wherein
the capacitance-voltage conversion circuit outputs a voltage corresponding to humidity based on capacitance which changes in relation to a relative permittivity of moisture in air and a substance having a relative permittivity different from that of the water provided in the humidity sensor.

15. The humidity sensor diagnosis device according to claim 1, wherein
the diagnosis unit switches to the same reference capacitor twice using the switch and confirms that a difference between two output voltages obtained by the capacitance-voltage conversion circuit when switching to the reference capacitor is within a certain range.
